(19) United States
(12) Patent Application Publication
(10) Pub. No.: US 2013/0275208 A1
(43) Pub. Date: Oct. 17, 2013

(54) COMPENSATION DETERMINATION IN DATA BROKERING ARRANGEMENTS

(71) Applicant: Searete LLC, a limited liability corporation of the State of Delaware, (US)

(72) Inventors: Gary W. Flake, Bellevue, WA (US); Royce A. Levien, Lexington, MA (US); Robert W. Lord, Seattle, WA (US); William Henry Mangione-Smith, Kirkland, WA (US); Richard F. Rashid, Redmond, WA (US); Clarence T. Tegreene, Mercer Island, WA (US); Lowell L. Wood, JR., Bellevue, WA (US)

(21) Appl. No.: 13/837,988

(22) Filed: Mar. 15, 2013

Related U.S. Application Data
(63) Continuation-in-part of application No. 13/828,804, filed on Mar. 14, 2013.
Application No. 13/828,804 is a continuation-in-part of application No. 13/827,853, filed on Mar. 14, 2013.
Application No. 13/827,853 is a continuation-in-part of application No. 12/804,770, filed on Jul. 27, 2010.
Application No. 12/804,770 is a continuation-in-part of application No. 12/229,506, filed on Aug. 21, 2008.
Application No. 12/229,506 is a continuation-in-part of application No. 12/221,465, filed on Jul. 31, 2008, now Pat. No. 8,473,388.
Application No. 12/221,465 is a continuation-in-part of application No. 12/221,203, filed on Jul. 30, 2008, now Pat. No. 8,473,387.
Application No. 12/221,203 is a continuation-in-part of application No. 12/220,918, filed on Jul. 28, 2008, now Pat. No. 8,468,073.
Application No. 12/220,918 is a continuation-in-part of application No. 12/217,138, filed on Jun. 30, 2008, now Pat. No. 8,429,040.

(51) Int. Cl. G06Q 30/02

(52) U.S. Cl. CPC G06Q 30/02
USPC 705/14.45; 705/14.54

(57) ABSTRACT

Systems and methods for data brokering, and more specifically, data brokering regarding a data provider's search-related activities, are described. In at least some implementations, a method in accordance with the present disclosure includes facilitating an arrangement between a data provider and a data consumer regarding one or more data-provider-related search activities, providing a data product to the data consumer in accordance with the arrangement, the data product including information regarding the one or more data-provider-related search activities, providing a consideration to the data provider in accordance with the arrangement, and receiving a second consideration from the data consumer in accordance with the arrangement.

### CROSS REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### Priority Applications

For purposes of the USPTO extra-statutory requirements, the present application constitutes a continuation-in-part of U.S. patent application Ser. No. 13/828,804, entitled SYSTEMS AND METHODS FOR MONITORING DATA BROKERING ARRANGEMENTS, naming Gary W. Flake, Royce A. Levien, Robert W. Lord, William Henry Mangione-Smith, Richard F. Rashid, Clarence T. Tegreene, and Lowell L. Wood, Jr. as inventors, filed Mar. 14, 2013 with attorney docket no. SE1-0043-US, which is currently co-pending or is an application of which a currently co-pending application is entitled to the benefit of the filing date, and which is a continuation-in-part of U.S. patent application Ser. No. 13/827,853, entitled SYSTEMS AND METHODS FOR BROKERING DATA PRODUCTS, naming Gary W. Flake, Royce A. Levien, Robert W. Lord, William Henry Mangione-Smith, Richard F. Rashid, Clarence T. Tegreene, and Lowell L. Wood, Jr. as inventors, filed Mar. 14, 2013 with attorney docket no. SE1-0042-US, which is currently co-pending or is an application of which a currently co-pending application is entitled to the benefit of the filing date, and which is a continuation-in-part of U.S. patent application Ser. No. 12/804,770, entitled FACILITATING DATA BROKERING ARRANGEMENTS HAVING AUCTIONING ASPECTS, naming Gary W. Flake, Royce A. Levien, Robert W. Lord, William Henry Mangione-Smith, Richard F. Rashid, Clarence T. Tegreene, and Lowell L. Wood, Jr. as inventors, filed Jul. 27, 2010 with attorney docket no. SE1-0041-US, which is currently co-pending or is an application of which a currently co-pending application is entitled to the benefit of the filing date, and which is a continuation-in-part of U.S. patent application Ser. No. 12/229,506, entitled FACILITATING COMPENSATION ARRANGEMENTS HAVING PRIVACY PRESERVATION ASPECTS, naming Gary W. Flake, Royce A. Levien, Robert W. Lord, William Henry Mangione-Smith, Richard F. Rashid, Clarence T. Tegreene, and Lowell L. Wood, Jr. as inventors, filed Aug. 21, 2008 with attorney docket no. SE1-0040-US, which is currently co-pending or is an application of which a currently co-pending application is entitled to the benefit of the filing date, and which is a continuation-in-part of U.S. patent application Ser. No. 12/221,465, entitled FACILITATING COMPENSATION ARRANGEMENTS PROVIDING FOR DATA TRACKING COMPONENTS, naming Gary W. Flake, Royce A. Levien, Robert W. Lord, William Henry Mangione-Smith, Richard F. Rashid, Clarence T. Tegreene, and Lowell L. Wood, Jr. as inventors, filed Jul. 31, 2008, with attorney docket no. SE1-0038C1-US, which is currently co-pending or is an application of which a currently co-pending application is entitled to the benefit of the filing date, and which is a continuation-in-part of U.S. patent application Ser. No. 12/221,203, entitled FACILITATING COMPENSATION ARRANGEMENTS BETWEEN DATA PROVIDERS AND DATA CONSUMERS, naming Gary W. Flake, Royce A. Levien, Robert W. Lord, William Henry Mangione-Smith, Richard F. Rashid, Clarence T. Tegreene, and Lowell L. Wood, Jr. as inventors, filed Jul. 30, 2008, with attorney docket no. SE1-0039-US, which is currently co-pending or is an application of which a currently co-pending application is entitled to the benefit of the filing date, and which is a continuation-in-part of U.S. patent application Ser. No. 12/220,918, entitled FACILITATING COMPENSATION ARRANGEMENTS PROVIDING FOR DATA TRACKING COMPONENTS, naming Gary W. Flake, Royce A. Levien, Robert W. Lord, William Henry Mangione-Smith, Richard F. Rashid, Clarence T. Tegreene, and Lowell L. Wood, Jr. as inventors, filed Jul. 28, 2008 with attorney docket no. SE1-0038-US, which is currently co-pending or is an application of which a currently co-pending application is entitled to the benefit of the filing date, and which is a continuation-in-part of U.S. patent application Ser. No. 12/217,138, entitled FACILITATING COMPENSATION ARRANGEMENTS FOR DATA BROKERING, naming Gary W. Flake, Royce A. Levien, Robert W. Lord, William Henry Mangione-Smith, Richard F. Rashid, Clarence T. Tegreene, and Lowell L. Wood, Jr. as inventors, filed Jun. 30, 2008 with attorney docket no. SE1-0037-US, which is currently co-pending or is an application of which a currently co-pending application is entitled to the benefit of the filing date.

### Related Applications

None.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### FIELD OF THE DISCLOSURE

The present disclosure relates generally to systems and methods for brokering data products.

### BACKGROUND

Individuals that engage in on-line activities, such as on-line search-related activities, typically generate information that may have value to other entities. Such information has often been surreptitiously monitored and gathered by various interested parties who, in turn, may make use of the information for commercial purposes (e.g. advertising).

### SUMMARY

The present disclosure teaches systems and methods for data brokering, and more specifically, data brokering regarding a data provider's search-related activities. In at least some implementations, a method in accordance with the present disclosure includes facilitating an arrangement between a data provider and a data consumer regarding one or more data-provider-related search activities, providing a data product to the data consumer in accordance with the arrangement, the data product including information regarding the one or more data-provider-related search activities, providing a consideration to the data provider in accordance with the arrangement, and receiving a second consideration from the data consumer in accordance with the arrangement.

This summary is intended to provide an introduction of a few exemplary aspects of implementations in accordance with the present disclosure. It is not intended to provide an exhaustive explanation of all possible implementations, and should thus be construed as merely introductory, rather than limiting, of the following disclosure.

### BRIEF DESCRIPTION OF THE DRAWINGS

FIG. 1 is a schematic view of a representative environment for brokering data in accordance with an implementation of the present disclosure.

FIG. 2 is a schematic view of an exemplary computing device configured to operate in accordance with another implementation of the present disclosure.

FIG. 3 is a flowchart of a method of brokering data in accordance with another implementation of the present disclosure.

FIGS. 4 through 14 are flowcharts of methods of facilitating compensation arrangements between data providers and data consumers in accordance with further implementations of the present disclosure.

### DETAILED DESCRIPTION

Techniques for brokering data regarding a data provider's search-related activities are disclosed. It should be appreciated that many specific details of certain implementations are set forth in the following description, and shown in the accompanying figures, to provide a thorough understanding of such implementations. One skilled in the art will understand from the teachings of the present disclosure, however, that the present disclosure may have other possible implementations, and that such other implementations may be practiced with/without some of the details set forth in the following description.

In the following discussion, an exemplary environment 100 for implementing one or more of the teachings of the present disclosure is described. Next, an exemplary computing device 200 for implementing one or more of the teachings of the present disclosure is described, followed by a description of various possible implementations of processes for data brokering in accordance with various implementations of the present disclosure.

Exemplary Environment

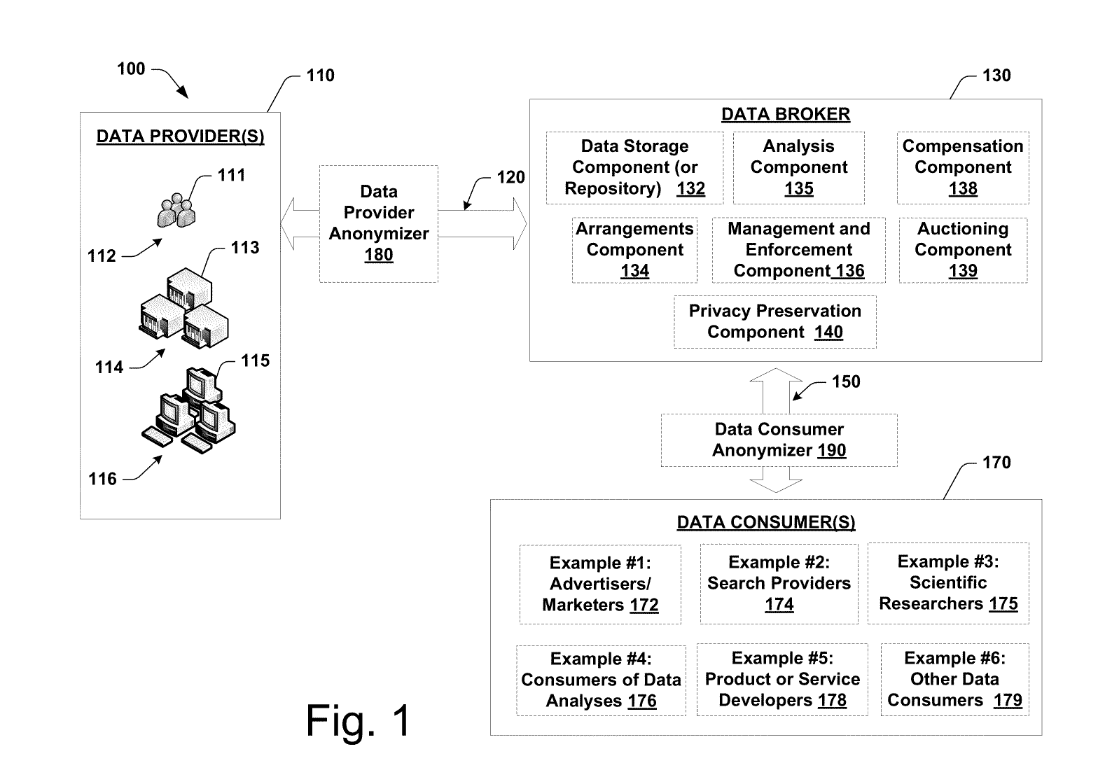

FIG. 1 is a schematic view of a representative environment 100 in accordance with an implementation of the present disclosure. In this implementation, the environment 100 includes one or more data providers 110, and one or more data consumers 170 who use the data generated by the data providers 110. In general, the data (or data products) generated by the data providers 110 may include a wide variety of information, including keywords, phrases, search terms, Universal Resource Locator (URL) data, browsing history, eyeballing history, time and quantity information, selection history, affinity-related information, health-related information, consumer-related information, personal-characteristic information, corporate (or other business entity) information, and any other suitable information.

The data providers 110 may include a variety of different providers and provider types. For example, in various implementations, the data providers 110 may include an individual 111, a group of individuals 112, an entity 113, a group of entities 114, a device 115, or a group of devices 116. In general, virtually any individual, entity, device, or groups thereof, may be a member of the data providers 110. For example, in various implementations, the individual 111 (or group of individuals 112) may include a computer user, consumer, person from a particular demographic group (e.g. age, gender, race, profession, religion, orientation, preference, geographic area, etc.), a particular bellwether or trendsetting individual (e.g. individual with popular ideas or tastes, athlete, performing artist, etc.), or any other suitable person.

Similarly, in various implementations, the entity 113 (or group of entities 114) may include a professional organization (e.g. Institute of Electrical and Electronics Engineers (IEEE), American Automobile Association (AAA), American Association of Retired Persons (AARP), etc.), company, university, union (e.g. United Auto Workers (UAW), International Affiliation of Writers Guilds, European Patent Lawyers Association (EPLA), etc.), consumer group (e.g. members of Costco®, Sam's Club®, Starwood®, etc.), club, association, (e.g. Boy Scouts of America, etc.), or any other suitable type of entity. Also, in various implementations, the device 115 (or group of devices 116) may include, for example, a computer, networking device, processor, personal communication device, or any other suitable type of device. Of course, other individuals, entities, and devices that may serve as data providers 110 may be conceived. More specifically, in particular implementations, any individual, entity, or device whose data may serve as an indicator of future consumption may suitably qualify such individual, entity, or device as a data provider 110.

The data consumers 170 may also include a variety of different consumers and consumer types. For example, in some specific implementations, the data consumers 170 may include advertisers or marketers 172, search providers 174, scientific researchers 175, consumers of data analyses 176, product or service developers 178, or any other data consumers 179. Data consumers 170 may also include any and all of the individuals, entities, and devices (or groups thereof) referenced above as data providers 110, or any other suitable types of data consumers. It will be appreciated that the data providers 110 and the data consumers 170 are not necessarily mutually exclusive groups, and that an entity may in some instances be a data provider, and in other instances a data consumer, or may even be both at the same time.

As further shown in FIG. 1, a data broker 130 operatively communicates with the one or more data providers 110 and the one or more data consumers 170. For example, communications (or interactions) 120 may be exchanged between the data broker 130 and the one or more data providers 110. The communications 120 may include, in some implementations, negotiation activities (e.g. offers, rejections, counteroffers, terms, conditions, provisions, etc.) which may lead to the establishment of one or more data provision agreements between the data providers 110 and the data broker 130. The communications 120 may also include communications relating to performance of established data provision agreements, including, for example, data transmissions, data receptions, access records, compensation exchanges, accounting exchanges, or any other suitable communications (or interactions) relating to data brokering.

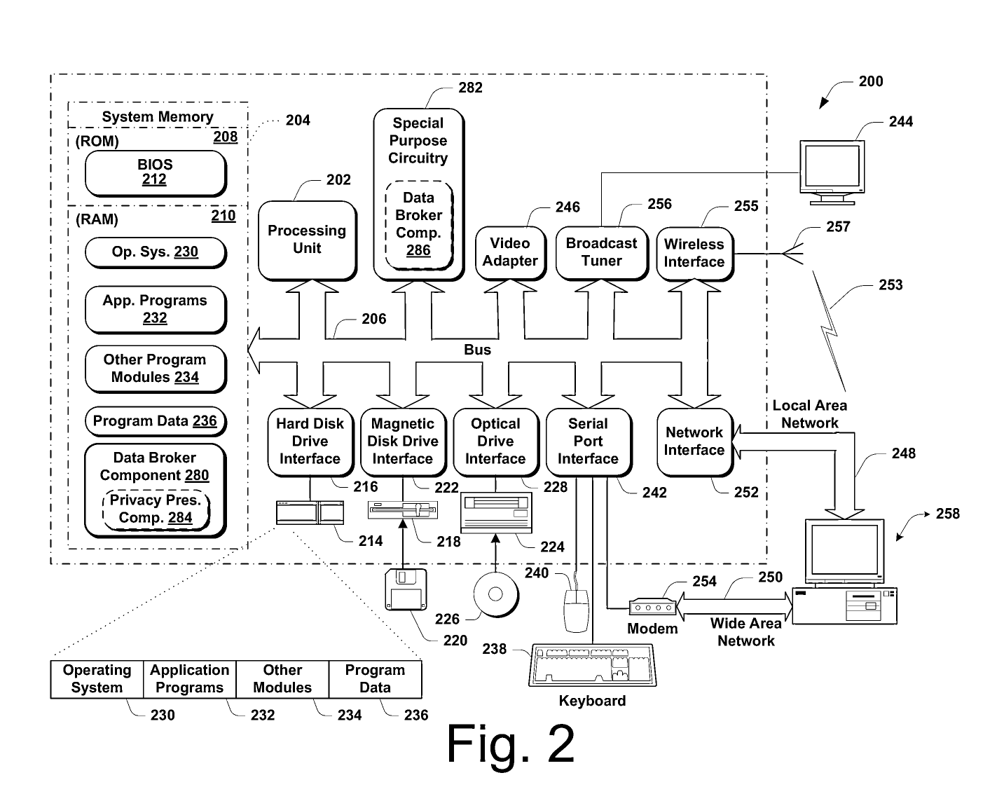

Such communications 120 may be exchanged via any suitable communications systems. For example, in some implementations the communications 120 may be exchanged via one or more of telephony (e.g. using the public switched telephone system), the internet (e.g., Voice over Internet Protocol), cellular telephone systems, satellite communication systems, instant messaging, text messaging, electronic mail (“email”), facsimiles, written communications, or any other suitable communications systems. Further, the communications 120 may be accomplished using any suitably operable couplings between the data broker 130 and the one or more data providers 110, including physical connections (e.g. wires, cables, fiber-optic lines, etc.), or wireless connections (e.g. radio-frequency connections between cell phone and cell network towers, satellite towers, etc.) and/or some combination of physical connections and wireless connections, and may be accomplished using one or more components of an exemplary computing device, such as a network interface, a wireless interface, a serial port interface, or any other suitable components (e.g. components or interfaces 216, 222, 228, 252, 242, 255 of FIG. 2).

Similarly, communications (or interactions) 150 between the data broker 130 and the one or more data consumers 170 may include, for example, negotiation activities (e.g. offers, rejections, counteroffers, terms, conditions, provisions, etc.) which may lead to the establishment of one or more data use agreements between the data providers 110 and the data broker 130. Also, the communications 150 may include communications relating to performance of established data use agreements, including, for example, data transmissions, data receptions, access records, compensation exchanges, accounting exchanges, or any other suitable communications (or interactions) relating to data brokering.

Again, such communications 150 may be exchanged via any suitable communications systems. For example, in some implementations the communications 150 may be exchanged via one or more of telephony (e.g. using the public switched telephone system), the internet (e.g., Voice over Internet Protocol), cellular telephone systems, satellite communication systems, instant messaging, text messaging, electronic mail (“email”), facsimiles, written communications, or any other suitable communications systems. Further, the communications 150 may be accomplished using any suitably operable couplings between the data broker 130 and the one or more data consumers 170, including physical connections (e.g. wires, cables, fiber-optic lines, etc.), or wireless connections (e.g. radio-frequency connections between cell phone and cell network towers, satellite towers, etc.) and/or some combination of physical connections and wireless connections, and may be accomplished using one or more components of an exemplary computing device, such as a network interface, a wireless interface, a serial port interface, or any other suitable components (e.g. components or interfaces 216, 222, 228, 252, 242, 255 of FIG. 2).

In some implementations, the data broker 130 may include one or more components that are operable to perform various functions and operations as described elsewhere herein. For example, the data broker 130 may include a data storage component 132, an arrangements component 134, an analysis component 135, a management and enforcement component 136, a compensation component 138, an auctioning component 139, and a privacy preservation component 140. It will be appreciated that the components of the data broker 130 shown in FIG. 1 are merely exemplary, and represent a possible implementation of the data broker 130. The functions and operations of the components 132-140 of the data broker 130 will be described more fully below.

As further shown in FIG. 1, the environment 100 may include a data provider anonymizer 180 that is operable to maintain an anonymity of each of the data providers 110 with respect to at least one of the data consumers 170, the data broker 130, or the other data providers 110. Similarly, the environment 100 may include a data consumer anonymizer 190 that is operable to maintain an anonymity of each of the data consumers 170 with respect to at least one of the data providers 110, the data broker 130, or the other data consumers 170. Although the anonymizers 180, 190 are depicted in FIG. 1 as existing independently of the other components or portions of the environment 100, in other implementations, the anonymizers 180, 190 may be disposed or distributed at any suitable locations throughout the environment 100, including, for example, within the data broker 130, or within one or more of the data providers 110 or the data consumers 170, respectively.

As noted above, in some implementations, the data broker 130 (FIG. 1) may include one or more components that are operable to perform various functions and operations as described herein. More specifically, in the exemplary implementation of the data broker 130 shown in FIG. 1, the data broker 130 includes a data storage component (or repository) 132, an arrangements component 134, an analysis component 135, a management and enforcement component 136, a compensation component 138, an auctioning component 139, and a privacy preservation component 140. Of course, in alternate implementations, one or more of these components 132-140 may be combined, separated into additional components, or eliminated, or additional components may be added, depending upon the particular requirements or specifications of the operating environment.

Various exemplary functionalities of the components 132-140 of the exemplary data broker 130 will now be described. It should be appreciated that the exemplary functionalities described below may be desirable in some implementations but not in others, and that unless otherwise specified, such exemplary functionalities are non-essential, and may be varied or omitted depending upon the desired operating characteristics of the implementation, or the particular requirements or specifications of the operating environment.

In some implementations, the data storage component 132 may be operable to receive and store data provided by the data providers 110. The data storage component 132 may organize the data by type, profile, data provider, value, or using any other suitable organizational structure. In some implementations, the data storage component 132 may perform verification activities, including monitoring and analyzing incoming data to ensure verity (e.g. accuracy, authenticity, etc.) of the information provided by the data providers 110.

In some implementations, the data provided by the data providers 110 may be included as part of the communications 120 described above. Furthermore, the data provided by the data providers 110 may be provided in any suitable form, including electrical signals, optical signals, acoustic signals, electromagnetic signals, modulated signals (e.g. frequency or amplitude modulated signals, etc.), binary signals, tabulated data, data records, data summaries, or any other suitable forms, and may be provided using any suitable communication media, including physical media (e.g. wires, cables, optical connectors, CD's, DVD's, printed or written data, etc.) non-physical transmission media (e.g. wireless transmissions), or any other suitable communication systems or methods.

In some implementations, the data storage component 132 may store additional information relating to the communications 120, 150 between the data broker 130 and the data providers 110 and the data consumers 170. For example, the data storage component 132 may store information relating to the functions and operations of any of the other components 134-140 of the data broker 130, including, for example, negotiation activities (e.g. offers, rejections, counteroffers, terms, conditions, provisions, etc.), established data provision agreements and data use agreements (e.g. terms and conditions regarding access, compensation, privacy, quality, quantity, usage, rights and restrictions, etc.), and information relating to performance of such established agreements (e.g. data transmissions, data receptions, access records, compensation exchanges, accounting exchanges, etc.). Various aspects of possible functions and operations of the other components 134-140 of the data broker 130 that may be stored within the data storage component 132 are described below.

Similarly, the arrangements component 134 may be operable to perform a variety of functions and operations associated with the data broker 130 via the communications 120, 150 between the data broker 130 and the data providers 110 and the data consumers 170. For example, in some implementations, the arrangements component 134 may be operable to perform negotiations of data brokering arrangements, including one or more of data provision agreements with data providers 110, or data use agreements with data consumers 170.

More specifically, in some implementations, the arrangements component 134 may be operable to create proposals, propose terms, receive offers to provide data, receive offers to consume data, receive requests for data analyses, identify potential data providers, identify potential data consumers, and perform other functions and operations associated with making arrangements with the data providers 110, the data consumers 170, or both. Additional aspects of data brokering that may be negotiated or performed by the arrangements component 134 are described below.

The analysis component 135 (FIG. 1) may also be operable to perform a variety of functions and operations associated with the data broker 130. For example, the analysis component 135 may be operable to perform an analysis or simulation using one or more components of the computing device 200 (e.g. the processing unit 202, the special purpose circuitry 282, the memory 204, the application programs 232, the program modules 234, the program data 236, etc.).

More specifically, in some implementations, the analysis component 135 may be operable to perform a desired analysis or simulation in response to a request by one or more of the data consumers 170 (or the data providers 110, or the data broker 130), such as to test a theory, to determine a potential value of data, to develop or validate a new model or hypothesis, to filter or glean relevant data from a quantity of raw data, or to perform any other suitable analysis or simulation. For example, the analysis component 135 may, at the request of one or more of the data consumers 170 (or the data providers 110, or the data broker 130) perform desired analyses or simulations, including mathematical manipulations of the data (e.g. interpolations, extrapolations, correlations, data fitting analyses, linear regressions, mathematical combinations, statistical analyses, Fourier analyses, Bayesian analyses, time-series analyses, etc.), model validation activities, model test activities, model development activities of suitable models (e.g. marketing models, consumption models, business models, economic models, etc.) that may use the data provided by the data providers 110.

The management and enforcement component 136 (FIG. 1) may be operable to monitor a performance of one or more of the data providers 110, the data broker 130, or the data consumers 170, in accordance with the arrangements established by the arrangements component 134. In some implementations, the management and enforcement component 136 may monitor performance by analyzing the communications 120 between the data providers 110 and the data broker 130, or the communications 150 between the data broker 130 and the data consumers 170. In other implementations, the management and enforcement component 136 may monitor the operations of one or more of the other components of the data broker 130 (e.g. the data storage component 132, the analysis component 135, the compensation component 138, etc.).

More specifically, the management and enforcement component 136 may perform one or more monitoring functions (e.g. access requests, traffic volumes, access periods, access volumes, consumer and provider identities, hits, usage rates, provision rates, etc.), recordkeeping functions (e.g. access requests, traffic volumes, access periods, access volumes, consumer and provider identities, hits, usage rates, provision rates, etc.), access control functions (e.g. data rights management, license terms, restrictions on usage, privacy and confidentiality provisions, etc.), notification functions including transmitting alerts, warnings, reminders, and notices regarding terms and conditions of data brokering agreements (e.g. usage rates and limits, provision rates and limits, spending rates and limits, quality assurance, usage restrictions, privacy restrictions, etc.), or any other suitable functions in accordance with the terms and conditions of the agreements established between the parties.

The functions and operations of the management and enforcement component 136 may be performed using software (e.g. traffic monitoring software, speed monitoring software, transfer rates recorder, bandwidth usage software, keystroke monitoring, etc.) that monitors, records, or captures upload and download activities (e.g. at one or more interfaces of a computing device 200, at the processor 202, at the memory 204, etc.), hardware (e.g. counters, meters, network cards, circuitry, etc.), firmware, or any suitable combination thereof.

With continued reference to FIG. 1, the compensation component 138 may be operable to determine the various amounts of compensation due from one or more of the data consumers 170, or to determine the various amounts of compensation owing to on or more of the data providers 110, or both. For example, the compensation component 138 may be operable to determine compensation due or owing using one or more components of the computing device 200 (e.g. with reference to FIG. 2, the processing unit 202, the special purpose circuitry 282, the memory 204, the application programs 232, the program modules 234, the program data 236, etc.).

In some implementations, the compensation component 138 may receive instructions or information to be used in determining compensation due or owing from one or more other components of the data broker 130. For example, in some implementations, the compensation component 138 may receive terms or instructions regarding compensation established by the arrangements component 134 (or the auctioning component 139). Similarly, the compensation component 138 may receive performance information from one or more other components of the data broker 130, including performance information from the management and enforcement component 136, the data storage component 132, the analysis component 135, or any other suitable component. In further implementations, the compensation component 138 may be operable to manage and implement a variety of compensation types, including upfront compensation, future compensation, contingent or conditional compensation, royalty-based compensation, auctioning-based compensation, non-monetary compensation, or any other suitable types of compensation. The compensation determined by the compensation component 138 may be provided by one or more of the communications 120 between the data providers 110 and the data broker 130, or the communications 150 between the data broker 130 and the data consumers 170.

The auctioning component 139 (FIG. 1) may be operable to perform functions and operations associated with the auctioning of data. For example, in some implementations, the auctioning component 139 may function in a manner substantially similar to the arrangements component 134, but may be operable to do so in an auctioning format. The auctioning component 139 may be operable to perform a variety of functions and operations associated with the data broker 130 via the communications 120, 150 between the data broker 130 and the data providers 110 and the data consumers 170. For example, in some implementations, the auctioning component 139 may be operable to perform negotiations of data brokering arrangements, including one or more of arranging or negotiating data provision agreements with data providers 110 via the communications 120, or arranging or negotiating data use agreements with data consumers 170 via the communications 150.

In some implementations, the auctioning component 139 may be operable to offer data products to a plurality of potential data consumers, to receive bids for use of the data, to evaluate the bids, to negotiate the terms and conditions, and to perform any other suitable auction-related functions. The auctioning component 139 may also be configured to create proposals, propose terms, receive offers to provide data, receive offers to consume data, receive requests for data analyses, identify potential data providers, identify potential data consumers, perform negotiations of one or more of data provision agreements and data use agreements, and perform other functions and operations associated with making arrangements with the data providers 110 and the data consumers 170.

The privacy preservation component 140 may be operable to maintain an anonymity of at least one of the data provider or the data consumer with respect to another of the data provider or the data consumer. For example, in some implementations, the privacy preservation component 140 may operate such that the data products provided to the data consumers 170 may be void of any identifying information about the data providers 110, thereby preventing the identity of the one or more data providers 110 from being revealed to the one or more data consumers 170. In other implementations, the privacy preservation component 140 is operable to maintain an anonymity of the data consumers 170 with respect to the data providers 110. Other possible functions, operations, and aspects of the privacy preservation component 140 are described more fully below.

It will be appreciated that the various possible functions, operations, and aspects of the privacy preservation component 140 may be performed by a software-based privacy preservation component (e.g. privacy preservation component 284 of FIG. 2), or a hardware or firmware-based privacy preservation component (e.g. privacy preservation circuitry 286 of FIG. 2), or any suitable combinations thereof. In some implementations, the various possible functions, operations, and aspects associated with privacy preservation and maintaining anonymity of one or more of the data providers 110 or the data consumers 170 may be distributed among one or more of the privacy preservation component 140, the data provider anonymizer 180, or the data consumer anonymizer 190.

In the implementation shown in FIG. 1, the various components 132-140 of the data broker 130 may communicate and exchange information as needed to perform the functions and operations described herein. In various implementations, each of the components 132-140 may be implemented using software, hardware, firmware, or any suitable combinations thereof. It will be appreciated that in alternate implementations of the data broker 130, one or more of the components 132-140 of the data broker 130 may be combined, or may be divided or separated into additional components, or additional components may be added, or one or more of the components 132-140 may simply be eliminated, depending upon the particular requirements or specifications of the operating environment. An exemplary computing device 200 for carrying out one or more of the functions and operations of the environment 100 is described in the following section.

Exemplary Computing Device

In some implementations, one or more of the components of the exemplary environment 100 shown in FIG. 1 may be at least partially implemented using a computing device. For example, FIG. 2 is a schematic view of an exemplary computing device 200 configured to operate in accordance with an implementation of the present disclosure. As described below, the computing device 200 can be configured to perform one or more of the functions and operations associated with the environment 100 shown in FIG. 1, and more specifically, one or more of the functions and operations associated with the data broker 130, or the one or more components 132-140 of the data broker 130.

As shown in FIG. 2, in some implementations, the computing device 200 may include one or more processors (or processing units) 202, special purpose circuitry 282 (e.g. Application Specific Integrated Circuits (ASICs), Field Programmable Gate Arrays (FPGAs), hardware accelerators, digital signal processors (DSPs), etc.), a memory 204, and a bus 206 that couples various system components including the memory 204 to the one or more processors 202 and special purpose circuitry 282. The bus 206 represents one or more of any of several types of bus structures, including a memory bus or memory controller, a peripheral bus, an accelerated graphics port, and a processor or local bus using any of a variety of bus architectures. In this implementation, the memory 204 includes read only memory (ROM) 208 and random access memory (RAM) 210. A basic input/output system (BIOS) 212, containing the basic routines that help to transfer information between elements within the computing device 200, such as during start-up, is stored in ROM 208.

The exemplary computing device 200 further includes a hard disk drive 214 for reading from and writing to a hard disk (not shown), and is connected to the bus 206 via a hard disk driver interface 216 (e.g., a SCSI, ATA, or other type of interface). A magnetic disk drive 218 for reading from and writing to a removable magnetic disk 220, is connected to the system bus 206 via a magnetic disk drive interface 222. Similarly, an optical disk drive 224 for reading from or writing to a removable optical disk 226 such as a CD ROM, DVD, or other optical media, connected to the bus 206 via an optical drive interface 228. The drives and their associated computer-readable media provide nonvolatile storage of computer readable instructions, data structures, program modules and other data for the computing device 200. Although the exemplary computing device 200 described herein employs a hard disk, a removable magnetic disk 220 and a removable optical disk 226, it should be appreciated by those skilled in the art that other types of computer readable media which can store data that is accessible by a computer, such as magnetic cassettes, flash memory cards, digital video disks, random access memories (RAMs) read only memories (ROM), and the like, may also be used.

As further shown in FIG. 2, a number of program modules may be stored on the memory 204 (e.g. the ROM 208 or the RAM 210) including an operating system 230, one or more application programs 232, other program modules 234, and program data 236. Alternately, these program modules may be stored on other computer-readable media, including the hard disk, the magnetic disk 220, or the optical disk 226. For purposes of illustration, programs and other executable program components, such as the operating system 230, are illustrated in FIG. 2 as discrete blocks, although it is recognized that such programs and components reside at various times in different storage components of the computing device 200, and may be executed by the processor(s) 202 or the special purpose circuitry 282 of the computing device 200.

A user may enter commands and information into the computing device 200 through input devices such as a keyboard 238 and a pointing device 240. Other input devices (not shown) may include a microphone, joystick, game pad, satellite dish, scanner, or the like. These and other input devices are connected to the processing unit 202 and special purpose circuitry 282 through an interface 242 that is coupled to the system bus 206. A monitor 244 or other type of display device is also connected to the bus 206 via an interface, such as a video adapter 246. In addition to the monitor, the computing device 200 may also include other peripheral output devices (not shown) such as speakers and printers.

The computing device 200 may operate in a networked environment using logical connections to one or more remote computers (or servers) 258, such as those operated by one or more of the data providers 110 and data consumers 170 shown in FIG. 1. Such remote computers (or servers) 258 may be a personal computer, a server, a router, a network PC, a peer device or other common network node, and may include many or all of the elements described above relative to computing device 200. The logical connections depicted in FIG. 2 (and in FIG. 1) may include one or more of a local area network (LAN) 248 and a wide area network (WAN) 250. Such networking environments are commonplace in offices, enterprise-wide computer networks, intranets, and the Internet. In this embodiment, the computing device 200 also includes one or more broadcast tuners 256. The broadcast tuner 256 may receive broadcast signals directly (e.g., analog or digital cable transmissions fed directly into the tuner 256) or via a reception device (e.g., via an antenna, a satellite dish, etc.).

When used in a LAN networking environment, the computing device 200 may be connected to the local network 248 through a network interface (or adapter) 252. When used in a WAN networking environment, the computing device 200 typically includes a modem 254 or other means for establishing communications over the wide area network 250, such as the Internet. The modem 254, which may be internal or external, may be connected to the bus 206 via the serial port interface 242. Similarly, the computing device 200 may exchange (send or receive) wireless signals 253 with one or more remote computers (or servers) 258, such as those operated by one or more of the data providers 110 and data consumers 170, using a wireless interface 255 coupled to a wireless communicator 257 (e.g., an antenna, a satellite dish, a transmitter, a receiver, a transceiver, a photoreceptor, a photodiode, an emitter, a receptor, etc.).

In a networked environment (e.g. environment 100 of FIG. 1), program modules depicted relative to the computing device 200, or portions thereof, may be stored in the memory 204, or in a remote memory storage device. More specifically, as further shown in FIG. 2, a data broker component 280 may be stored in the memory 204 of the computing device 200. The data broker component 280 may include an implementation of the data broker 130 of FIG. 1, or one or more components 132-140 of the data broker 130, such as a privacy preservation component 284. The data broker component 280 may be implemented using software, hardware, firmware, or any suitable combinations thereof. For example, in some implementations, one or more of the operations of the data broker 130 may be implemented in the special purpose circuitry 282 (e.g. as data broker component 286), and may be operable to perform one or more operations associated with data brokering described elsewhere herein. In cooperation with the other components of the computing device 200, such as the processing unit 202 or the special purpose circuitry 282, the data broker component 280 may be operable to perform one or more implementations of processes for data brokering in accordance with the present disclosure.

Exemplary Processes for Brokering Data Products

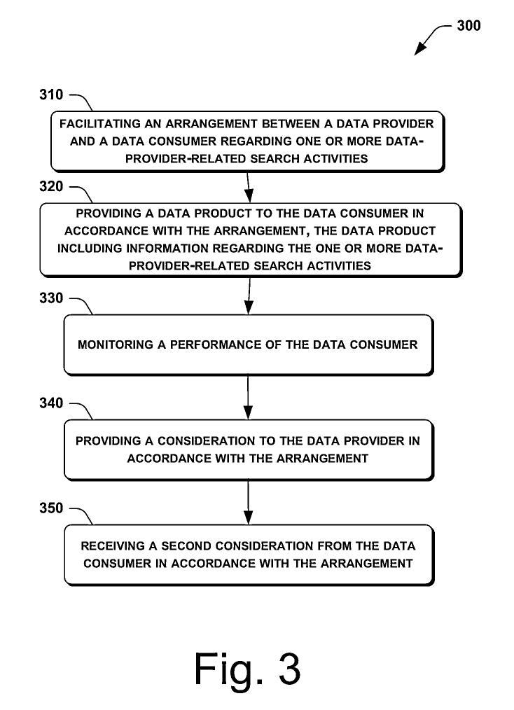

Exemplary processes for brokering data products will now be described. For convenience, and to facilitate an understanding of these processes, the exemplary processes will be described with reference to the exemplary environment 100 and exemplary computing device 200 described above. For ease of understanding, the flowcharts are organized such that the initial flowchart (FIG. 3) presents an overall “big picture” viewpoint, and thereafter the following flowcharts present possible particular implementations and/or expansions of the “big picture” flowcharts as either sub-steps or additional steps building on one or more earlier-presented flowcharts. Those having skill in the art will appreciate that the style of presentation utilized herein (e.g., beginning with a presentation of a flowchart(s) presenting an overall view and thereafter providing additions to and/or further details in subsequent flowcharts) generally allows for a rapid and efficient understanding of the various process instances.

FIG. 3 is a flowchart of a method of brokering data 300 in accordance with another implementation of the present disclosure. In this implementation, the method 300 includes facilitating an arrangement between a data provider and a data consumer regarding one or more data-provider-related search activities at 310 (e.g. negotiating for monetary payments to be paid to an individual by an advertiser in exchange for access to the individual's online search terms; agreeing to provide a discount on goods or services to members of an association in exchange for access to information related to browsing histories of the association's members; providing access to scientific literature to a group of scientists by a seller of scientific supplies in exchange for authorization to gather data regarding the group's accessing of the scientific literature; etc.). The method 300 may further include providing a data product to the data consumer in accordance with the arrangement, the data product including information regarding the one or more data-provider-related search activities at 320 (e.g. allowing a data consumer to access a specified quantity of search-related information stored in a data repository; transmitting a computer user's search terms to a marketing consultant on a periodic basis; downloading a browsing history to an online retailer in pre-determined increments, providing an RSS feed of online search activities to an advertiser in a real-time manner, etc.).

In some implementations, monitoring a performance of the data consumer at 330 (e.g. detecting a quantity of search-related information accessed by the data consumer; monitoring a benefit realized by a marketer attributable (or presumably attributable) to data provided to the marketer; measuring an increase in “hits” experienced by an online retailer; sensing a quantum of information analyzed by or on behalf of the data consumer; etc.). In at least some implementations, monitoring a performance of the data consumer at 330 may be performed using software that monitors, records, or captures a user's activities (e.g. traffic monitoring software, speed monitoring software, transfer rates recorder, bandwidth usage software, keystroke monitoring, etc.), hardware (e.g. counters, meters, network cards, circuitry, etc.), firmware, or any suitable combination thereof. In further implementations, monitoring a performance of the data consumer at 330 may include one or more of monitoring activities (e.g. access requests, traffic volumes, access periods, access volumes, consumer and provider identities, hits, usage rates, provision rates, etc.), recordkeeping activities (e.g. access requests, traffic volumes, access periods, access volumes, consumer and provider identities, hits, usage rates, provision rates, etc.), access control activities (e.g. data rights management, license terms, restrictions on usage, privacy and confidentiality provisions, etc.), notification activities (e.g. transmitting alerts, warnings, reminders, notices, rates and limits, quality assurance, restrictions, etc.), capturing activities, or any other suitable functions in accordance with the terms and conditions of one or more of the agreements established between the parties.

As further shown in FIG. 3, in at least some implementations, the method 300 may further include providing a consideration to the data provider in accordance with the arrangement at 340, and receiving a second consideration from the data consumer in accordance with the arrangement at 350. The consideration received from the data consumer, and the consideration provided to the data provider, may be any suitable type of compensation, including monetary payments, credits, privileges, products or services, upfront compensation, future compensation, contingent or conditional compensation, royalty-based compensation, auctioning-based compensation, non-monetary compensation, or any other suitable types of consideration. In addition, the type of the first consideration received from the data consumer may be of the same type, or may be of a different type or quality or quantity, than the second consideration provided to the data provider. In some implementations, providing a consideration to the data provider in accordance with the arrangement at 340, and/or receiving a second consideration from the data consumer in accordance with the arrangement at 350, may be accomplished using, for example, electronic (wire or wireless) transfers of funds, electronic payments, credits and debit transactions, transmittals of checks or other negotiable instruments, or any other suitable methods of compensation exchange.

In general, in at least some implementations, the method 300 may be accomplished using the communications 120 between the data providers 110 and the data broker 130, or the communications 150 between the data broker 130 and the data consumer 170, or both. Additionally, in some implementations, the method 300 may be implemented via one or more of telephony (e.g. using the public switched telephone system), the internet (e.g., Voice over Internet Protocol), cellular telephone systems, satellite communication systems, instant messaging, text messaging, electronic mail (“email”), facsimiles, written communications, or any other suitable communications systems.

It will also be appreciated that the method 300 may be implemented using any suitably operable couplings between the data broker 130 and the one or more data providers 110 and data consumers 170, including physical connections (e.g. wires, cables, fiber-optic lines, etc.), or wireless connections (e.g. radio-frequency connections between cell phone and cell network towers, satellite towers, etc.) and/or some combination of physical connections and wireless connections, and may be accomplished using computing devices (e.g. computing device 200, servers, laptops, mainframes, personal data assistants, cell phones, etc.), or using one or more components of such devices (e.g. processors 202, special purpose circuitry 282, application programs 232, other program modules 234, program data 236, network interface 252, wireless interface 255, serial port interface 242, other interfaces 216, 222, 228, etc.).

The preceding description has presented an exemplary “big picture” overview of possible implementations of processes in accordance with the present disclosure. In the following discussion, additional details of exemplary particular implementations are described.

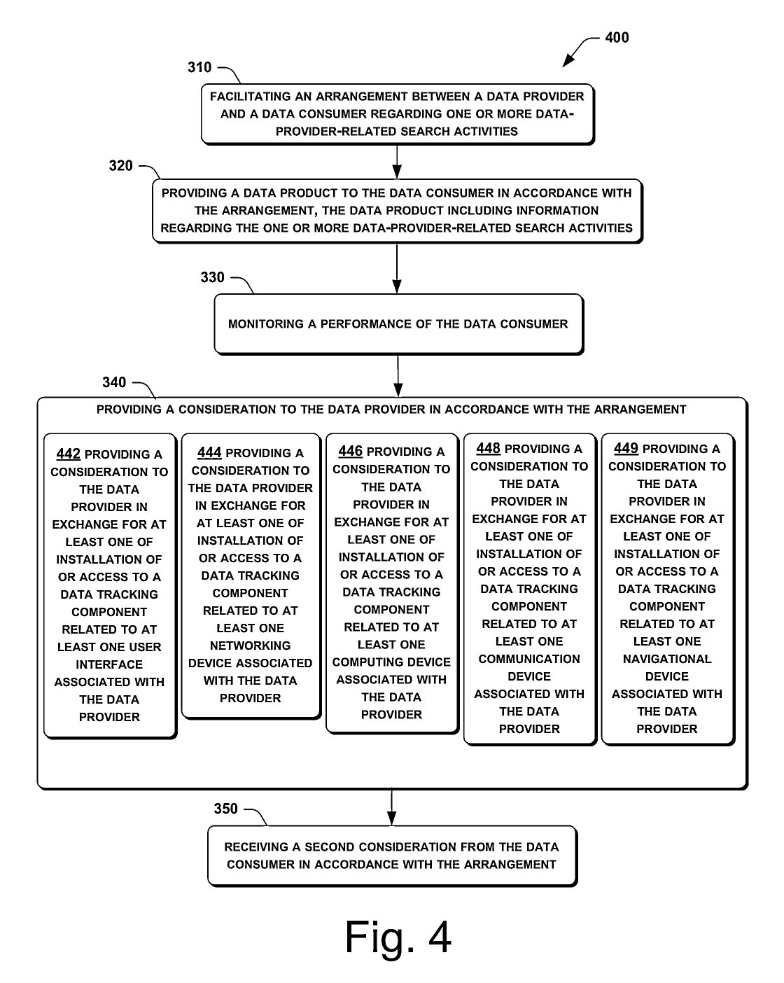

It will be appreciated that providing a consideration to the data provider in accordance with the arrangement at 340, and/or receiving a second consideration from the data consumer in accordance with the arrangement at 350, may be implemented in a variety of ways. For example, as shown in FIG. 4, in at least some implementations, providing a consideration to the data provider in accordance with the arrangement at 340 may include providing a consideration to the data provider in exchange for at least one of installation of or access to a data tracking component related to at least one user interface associated with the data provider at 442 (e.g. installing a cookie that track's a person's browsing activities via keystrokes, installing a metering software or circuit that measures a volume of displayed content via a display device, etc.). In other implementations, providing a consideration to the data provider in accordance with the arrangement at 340 may include providing a consideration to the data provider in exchange for at least one of installation of or access to a data tracking component related to at least one networking device associated with the data provider at 444 (e.g. installing a tracking application that track's a person's browsing activities via traffic on a network server, installing a metering software or circuit that measures a volume of downloaded content through a network router or switch, etc.).

In further implementations, providing a consideration to the data provider in accordance with the arrangement at 340 may include providing a consideration to the data provider in exchange for at least one of installation of or access to a data tracking component related to at least one computing device associated with the data provider at 446 (e.g. installing a tracking application that track's a person's searching activities via traffic on a tablet, installing a metering software or circuit that measures a volume of downloaded content on a laptop or desktop computer, etc.). In further implementations, providing a consideration to the data provider in accordance with the arrangement at 340 may include providing a consideration to the data provider in exchange for at least one of installation of or access to a data tracking component related to at least one communication device associated with the data provider at 448 (e.g. installing a tracking application that track's a person's searching activities via traffic on a cellular phone, installing a metering software or circuit that measures a volume of downloaded content on a personal digital assistant, etc.). Similarly, in some implementations, providing a consideration to the data provider in accordance with the arrangement at 340 may include providing a consideration to the data provider in exchange for at least one of installation of or access to a data tracking component related to at least one navigational device associated with the data provider at 449 (e.g. installing a tracking application that track's a person's activities via a navigational application on a cellular phone, installing a metering software or circuit that monitors activity on a GPS device in an automobile, etc.).

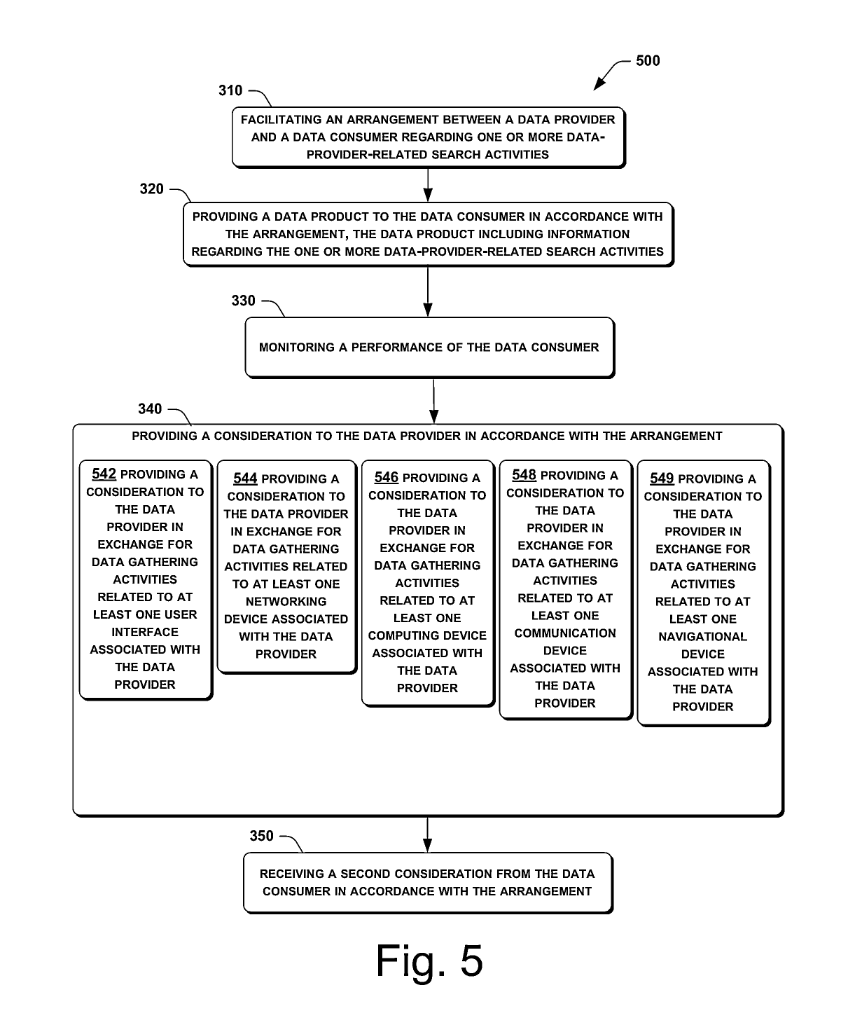

As shown in FIG. 5, in at least some implementations, providing a consideration to the data provider in accordance with the arrangement at 340 may include providing a consideration to the data provider in exchange for data gathering activities related to at least one user interface associated with the data provider at 542 e.g. monitoring a person's browsing activities via keystrokes, measuring a volume of displayed content via a display device, etc.). In other implementations, providing a consideration to the data provider in accordance with the arrangement at 340 may include providing a consideration to the data provider in exchange for data gathering activities related to at least one networking device associated with the data provider at 544 (e.g. monitoring a person's browsing activities via traffic on a network server, tracking a volume of downloaded content through a network router or switch, etc.).

In further implementations, providing a consideration to the data provider in accordance with the arrangement at 340 may include providing a consideration to the data provider in exchange for data gathering activities related to at least one computing device associated with the data provider at 446 (e.g. monitoring a person's searching activities via traffic on a tablet, measuring a volume of downloaded content on a laptop or desktop computer, etc.). In further implementations, providing a consideration to the data provider in accordance with the arrangement at 340 may include providing a consideration to the data provider in exchange for data gathering activities related to at least one communication device associated with the data provider at 548 (e.g. monitoring a person's searching activities via traffic on a cellular phone, measuring a volume of downloaded content on a personal digital assistant, etc.). Similarly, in some implementations, providing a consideration to the data provider in accordance with the arrangement at 340 may include providing a consideration to the data provider in exchange for data gathering activities related to at least one navigational device associated with the data provider at 549 (e.g. monitoring a person's activities via a navigational application on a cellular phone, tracking activity on a GPS device in an automobile, etc.).

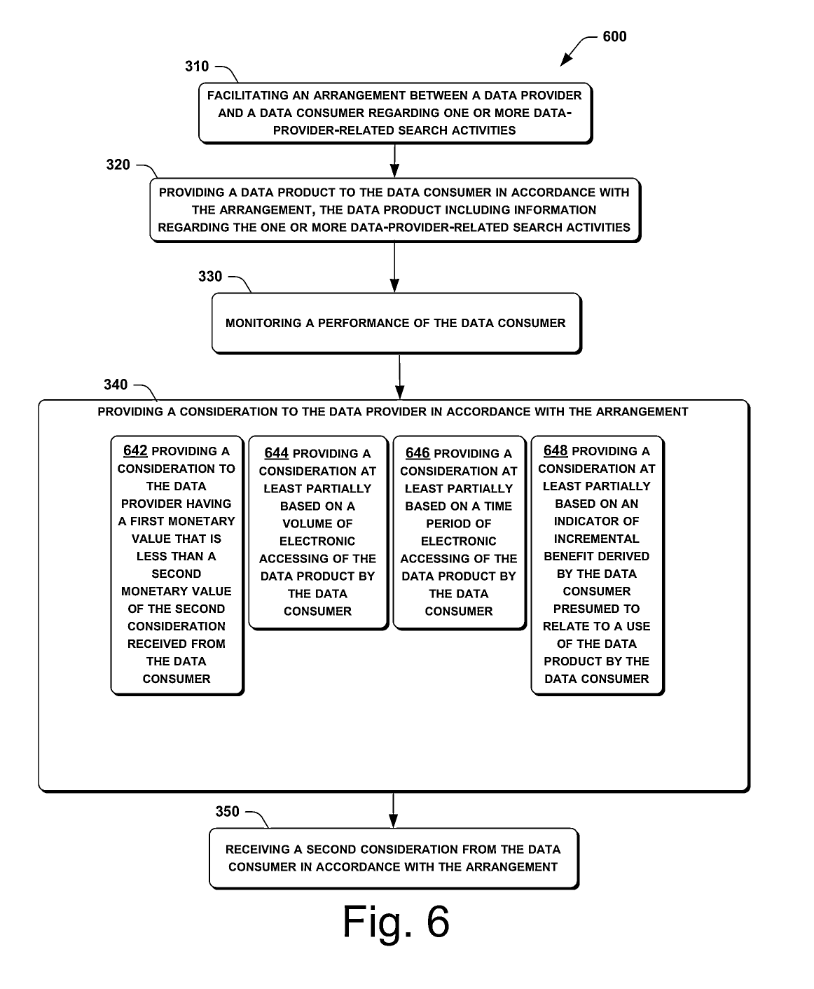

As shown in FIG. 6, in at least some implementations, providing a consideration to the data provider in accordance with the arrangement at 340 may include may include providing a consideration to the data provider having a first monetary value that is less than a second monetary value of the second consideration received from the data consumer at 642 (e.g. receiving a higher payment from a marketing firm that purchases access to the data than is paid to the company that provides access to the data, etc.). In other implementations, providing a consideration to the data provider in accordance with the arrangement at 340 may include providing a consideration at least partially based on a volume of electronic accessing of the data product by the data consumer at 644 (e.g. providing a payment that is at least partially based on a number of users whose searching-related activities are being tracked, providing a payment that is at least partially based on a quantity of search-related records being accessed by the marketing firm, etc.).

In further implementations, providing a consideration to the data provider in accordance with the arrangement at 340 may include providing a consideration at least partially based on a time period of electronic accessing of the data product by the data consumer at 646 (e.g. providing a payment that is at least partially based on a number of minutes spent reviewing the data product, providing a payment that is at least partially based on a monthly subscription allowing access to the data product, etc.). In still other implementations, providing a consideration to the data provider in accordance with the arrangement at 340 may include providing a consideration at least partially based on an indicator of incremental benefit derived by the data consumer presumed to relate to a use of the data product by the data consumer at 648 (e.g. providing a payment that is at least partially based on an increased number of sales attributable to a marketing firm's use of the data product, etc.).

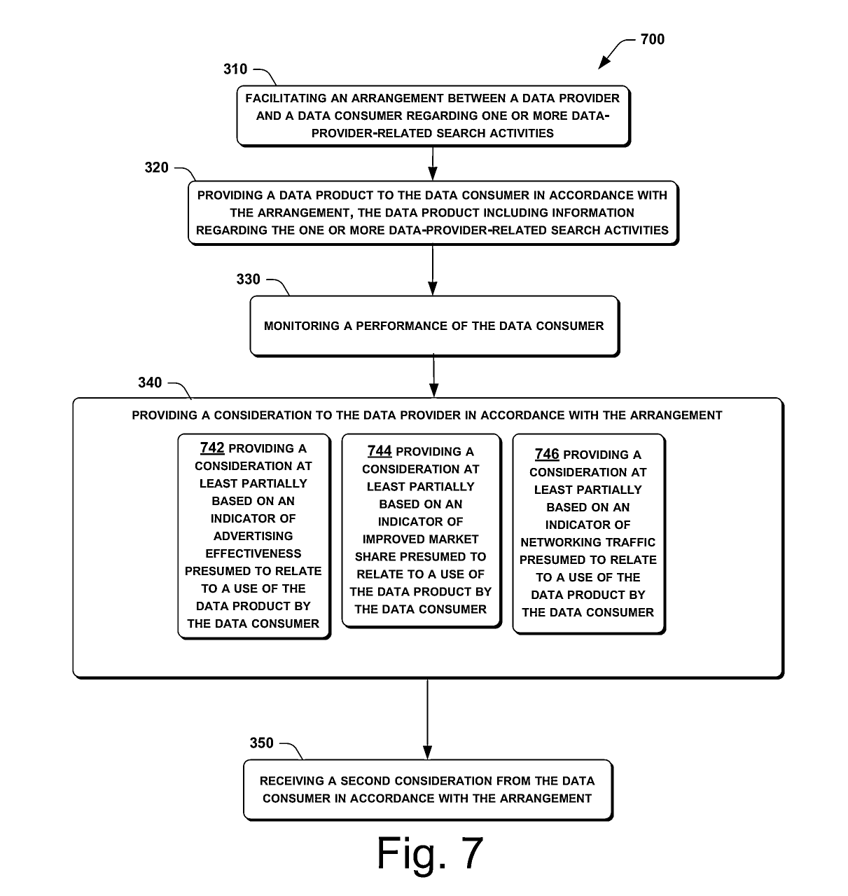

As shown in FIG. 7, in at least some implementations, providing a consideration to the data provider in accordance with the arrangement at 340 may include providing a consideration at least partially based on an indicator of advertising effectiveness presumed to relate to a use of the data product by the data consumer at 752 (e.g. providing a payment that is at least partially based on an increased number of patrons visiting a retail outlet attributable to a retailer's use of the data product, providing a payment that is at least partially based on an increased number of visitors to an online store attributable to the online seller's use of the data product, etc.). In other implementations, providing a consideration to the data provider in accordance with the arrangement at 340 may include providing a consideration at least partially based on an indicator of improved market share presumed to relate to a use of the data product by the data consumer at 734 (e.g. providing a payment that is at least partially based on a statistical analysis of sales, etc.). In further implementations, providing a consideration to the data provider in accordance with the arrangement at 340 may include providing a consideration at least partially based on an indicator of networking traffic presumed to relate to a use of the data product by the data consumer at 746 (e.g. providing a payment that is at least partially based on an increased number of website “hits” attributable to a retailer's use of the data product, providing a payment that is at least partially based on an increased number of followers on Twitter®, likes on Facebook®, or other social media site, attributable to a retailer's use of the data product, etc.).

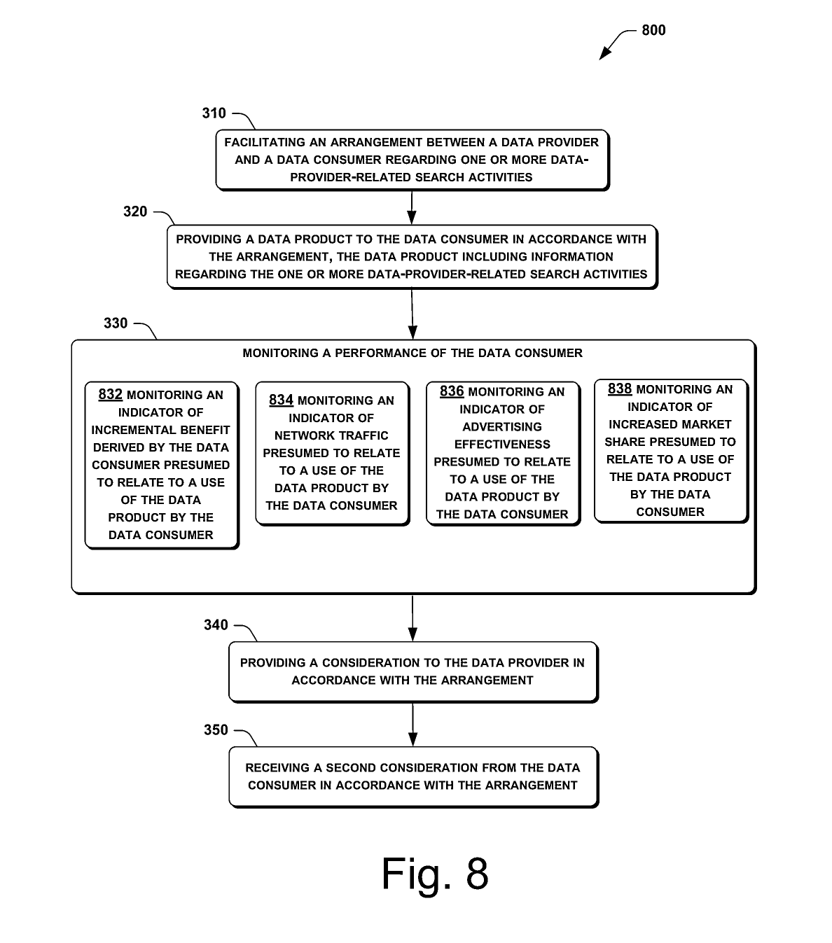

As shown in FIG. 8, in at least some implementations, monitoring a performance of the data consumer at 330 may include monitoring an indicator of incremental benefit derived by the data consumer presumed to relate to a use of the data product by the data consumer at 832. In other implementations, monitoring a performance of the data consumer at 330 may include monitoring an indicator of networking traffic presumed to relate to a use of the data product by the data consumer at 834. In still other implementations, monitoring a performance of the data consumer at 330 may include monitoring an indicator of advertising effectiveness presumed to relate to a use of the data product by the data consumer at 836. In additional implementations, monitoring a performance of the data consumer at 330 may include monitoring an indicator of increased market share presumed to relate to a use of the data product by the data consumer at 838.

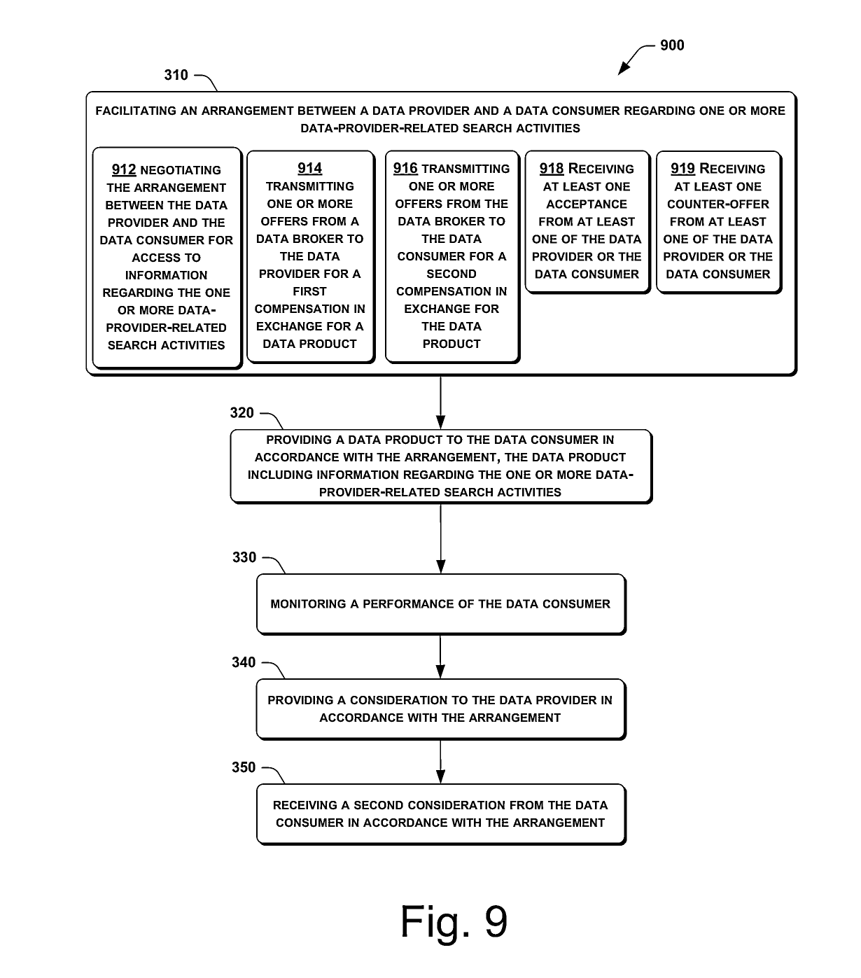

As shown in FIG. 9, in at least some implementations, facilitating an arrangement between a data provider and a data consumer regarding one or more data-provider-related search activities at 310 may include negotiating the arrangement between the data provider and the data consumer for access to information regarding the one or more data-provider-related search activities at 912. In other implementations, facilitating an arrangement between a data provider and a data consumer regarding one or more data-provider-related search activities at 310 may include transmitting one or more offers from a data broker to the data provider for a first compensation in exchange for a data product at 914 (e.g. transmitting an offer from a data broker to an association of consumers for a specified sum of money per unit of data in exchange for purchasing data regarding the one or more specified consumers; offering to provide to a service consumer a discount on consumed services in exchange for data regarding service usage; etc.). In still other implementations, facilitating an arrangement between a data provider and a data consumer regarding one or more data-provider-related search activities at 310 may include transmitting one or more offers from the data broker to the data consumer for a second compensation in exchange for the data product at 916 (e.g. transmitting an offer from a broker of data to a consumer of data for a discount on goods sold by the data consumer in exchange for purchasing data, transmitting an offer from a data broker to a market research consultant for a relatively-higher specified sum of money per unit of data in exchange for purchasing data regarding one or more specified consumers, etc.).

As further shown in FIG. 9, in some implementations, facilitating an arrangement between a data provider and a data consumer regarding one or more data-provider-related search activities at 310 may include receiving at least one acceptance from at least one of the data provider or the data consumer at 918 (e.g. receiving an acceptance from a market research consultant for a specified sum of money per unit of data in exchange for purchasing data, receiving an acceptance at the broker of data from a consumer of services for a discount on services in exchange for data regarding usage of such services, etc.). Similarly, in some implementations, facilitating an arrangement between a data provider and a data consumer regarding one or more data-provider-related search activities at 310 may include receiving at least one counter-offer from at least one of the data provider or the data consumer at 919 (e.g. receiving a counter-offer at the data broker from a market research consultant for a relatively-lower specified sum of money per unit of data in exchange for purchasing data; receiving a counter-offer from a consumer of services for a relatively-lower discount on services in exchange for data regarding usage of such services, etc.).

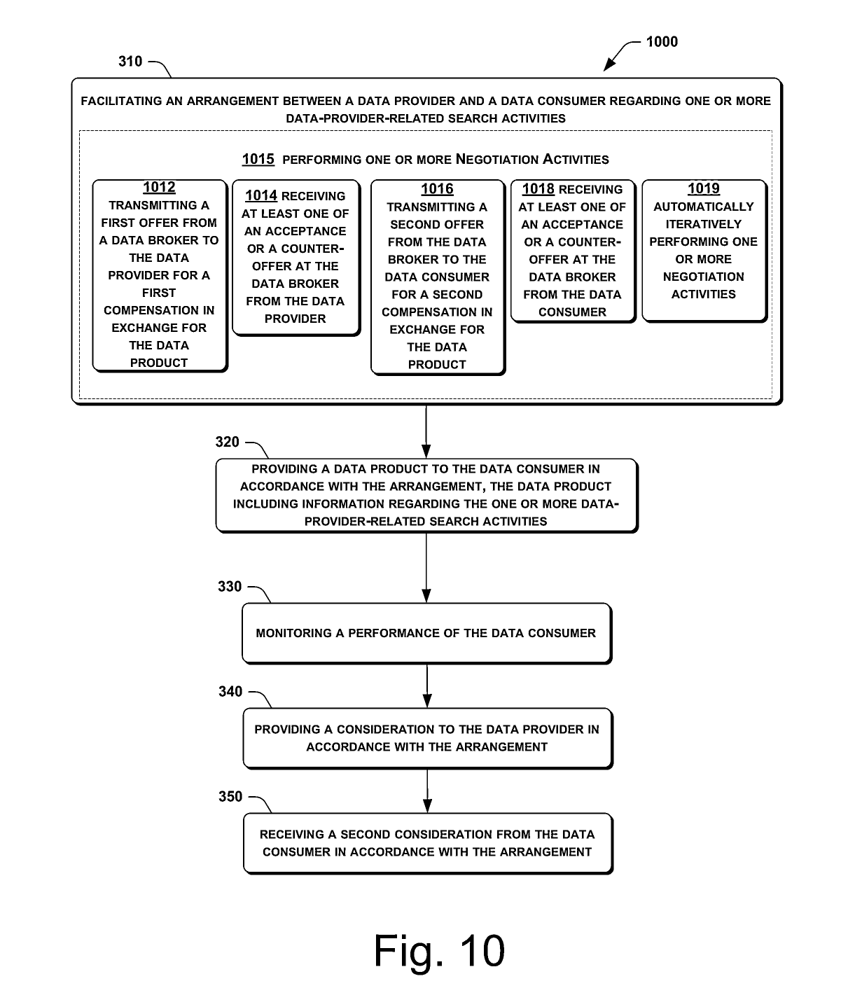

As shown in FIG. 10, in some implementations, facilitating an arrangement between a data provider and a data consumer regarding one or more data-provider-related search activities at 310 may include performing one or more negotiation activities at 1015 (e.g. performing one or more of creating proposals, proposing terms, receiving offers to provide data, receiving offers to consume data, receiving requests for data analyses, identifying potential data providers, identifying potential data consumers, or performing other functions and operations). For example, in exemplary implementations, performing one or more negotiation activities at 1015 may include at least one of: transmitting a first offer from a data broker to the data provider for a first compensation in exchange for the data product at 1012 (e.g. transmitting an offer from a broker to a union of workers for payment of a specified sum in exchange for a specified volume of data regarding online purchasing activities of the workers); receiving at least one of an acceptance or a counter-offer at the data broker from the data provider at 1014 (e.g. receiving an offer at the broker from the union of workers for payment of a higher sum in exchange for the specified volume of data regarding online purchasing activities of the workers); transmitting a second offer from the data broker to the data consumer for a second compensation in exchange for the data product at 1016 (e.g. transmitting a second offer from the broker to the union of workers for payment of an intermediate sum in exchange for the specified volume of data regarding online purchasing activities of the workers); receiving at least one of an acceptance or a counter-offer at the data broker from the data consumer at 1018 (e.g. receiving an acceptance at the broker from a market research entity for payment of another specified sum in exchange for the specified volume of data regarding online purchasing activities of the workers); or automatically iteratively performing one or more negotiation activities at 1019 (e.g. if a previous offer is not accepted by a potential data provider, automatically extending another offer that is 2% higher than the previous offer up to a specified upper limit; if a previous offer is not accepted by a potential data consumer, automatically extending another offer that is 2% lower than the previous offer down to a specified lower limit).

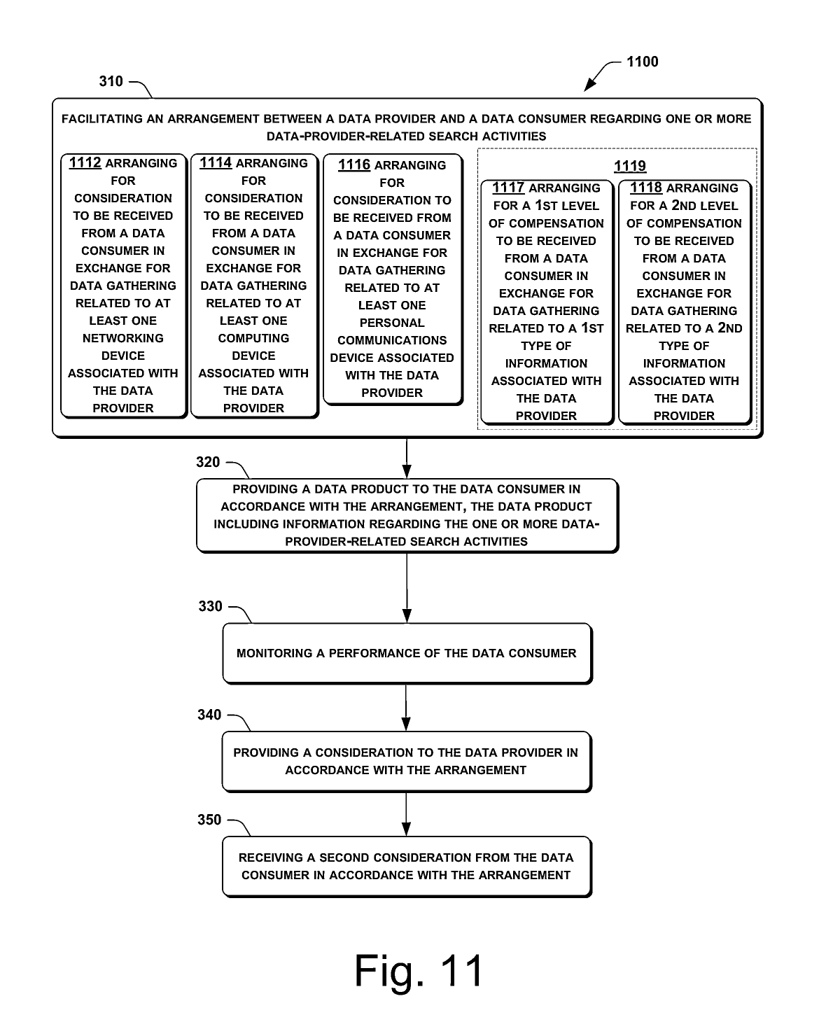

In some implementations, the terms and conditions associated with the compensation arrangements may also be facilitated. For example, as shown in FIG. 11, in some implementations, facilitating an arrangement between a data provider and a data consumer regarding one or more data-provider-related search activities at 310 may include arranging for consideration to be received from a data consumer in exchange for data gathering related to at least one networking device associated with the data provider at 1112 (e.g. arranging for a monthly transfer of funds from a bank account of a search provider into a bank account of a company or individual for data gathering from a server owned by the data provider; establishing a credit account at a retail outlet for members of a data-providing organization; providing for an issuance of discount coupons to an individual that owns or operates equipment that provides a data product to a data consumer, establishing a payment schedule from a market research department to an entity for information received from a computer, server, switch, firewall, security appliance, cellular phone, a personal data assistant (PDA), television, etc. associated with the entity).

In other implementations, facilitating an arrangement between a data provider and a data consumer regarding one or more data-provider-related search activities at 310 may include arranging for compensation to be received from a data consumer in exchange for data gathering related to at least one computing device associated with the data provider at 1114 (e.g. arranging for a swap of computer equipment from an OEM in exchange for quarterly data gathering associated with a company's desktop computers, laptop computers, notebook computers, mainframe computers, servers, PDAs, etc.). In further implementations, facilitating an arrangement between a data provider and a data consumer regarding one or more data-provider-related search activities at 310 may include arranging for compensation to be received from a data consumer in exchange for data gathering related to at least one personal communications device associated with the data provider at 1116 (e.g. providing for a monthly fee to a real estate agent for data gathered from the agent's cellular phone, PDA, navigational device, laptop, mobile communication device, etc.).

As further shown in FIG. 11, in further implementations, facilitating an arrangement between a data provider and a data consumer regarding one or more data-provider-related search activities at 310 may include arranging for a first level of compensation to be received from a data consumer in exchange for data gathering related to a first type of information associated with the data provider at 1117, arranging for a second level of compensation to be received from the data consumer in exchange for data gathering related to a second type of information associated with the data provider, the second level of compensation being different than the first level of compensation at 1118, or both at 1119. For example, in some implementations, such arranging includes arranging for a higher level of payment (e.g. $1 per x number of search terms, 1000 yen per Terrabyte of information, etc.) for data gathering related to a data provider's health-related interests (e.g. high blood pressure, cancer, naturopathic treatments, acupuncture, anxiety medications, etc.), and a lower level of payment (e.g. $0.01 per x number of search terms, 1 yen per TB, free movie passes, etc.) for data gathering related to the data provider's hobby-related interests (e.g. favorite sports, travel interests, painting, crafts, coin collecting, etc.), or vice versa.

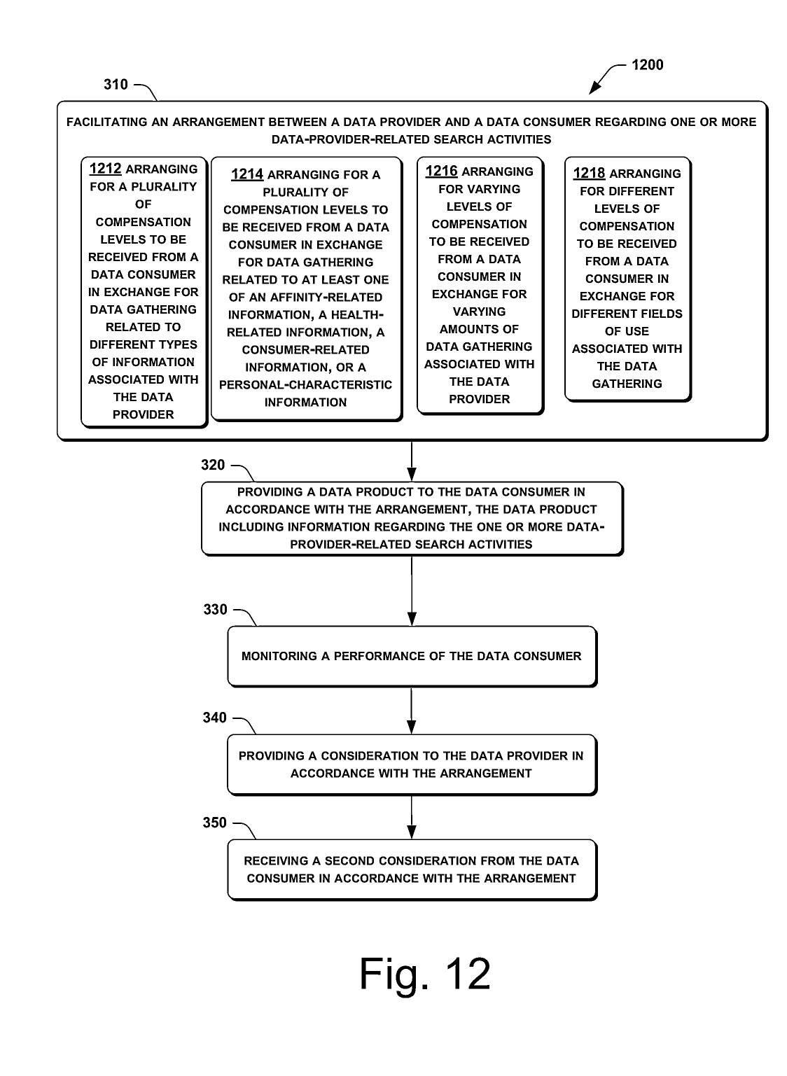

In some implementations, a plurality of compensation levels may be arranged in exchange for data gathering related to different types of information. For example, as shown in FIG. 12, in at least some implementations, facilitating an arrangement between a data provider and a data consumer regarding one or more data-provider-related search activities at 310 may include arranging for a plurality of compensation levels to be received from a data consumer in exchange for data gathering related to different types of information associated with the data provider at 1212 (e.g. establishing a premium level of payment for consumer-related information (e.g. purchasing habits, credit habits, etc.), a standard level of payment for personal-characteristic information (e.g. gender, age, education, employment status, marital status, etc.), and a discount compensation level (e.g. store credit, coupon, etc.) for all other information associated with the data provider.

In other implementations, facilitating an arrangement between a data provider and a data consumer regarding one or more data-provider-related search activities at 310 may include arranging for a plurality of compensation levels to be received from a data consumer in exchange for data gathering related to at least one of an affinity-related information, a health-related information, a consumer-related information, a personal-characteristic-related information, or a business-entity-related information at 1214. For example, in some implementations, such arranging may include arranging for a first compensation in exchange for data gathering related to affinity-related information (e.g. sports affinity information, religious affinity information, music affinity information, literature affinity information, theater affinity information, film affinity information, television program affinity information, hobby affinity information, service affinity information, product affinity information, etc.), a second compensation for health-related information (e.g. an ailment-related information, a condition-related information, a disease-related information, a treatment-related information, a prevention-related information, a diet-related information, an exercise-related information, a mental-health related information, or a wellness-related information, etc.), a third compensation for consumer-related information (e.g. a purchasing-related information, a spending-related information, an income-related information, a credit-worthiness-related information, a subscription-related information, an ordering-related information, a shopping-related information, a browsing-related information, a credit card-related information, a debit card-related information, a check writing-related information, a delivery-related information, a coupon-related information, a selling-method-related information, an offering-related information, a promotional-event-related information, an advertising-related information, etc.), a fourth compensation level for personal-characteristic information (e.g. an age-related information, a gender-related information, a race-related information, an income-related information, a geographic location-related information, a marital status-related information, an education-related information, an employment-related information, a sexual orientation-related information, a cultural-related information, a personality characteristic-related information, a demographic-related information, etc.), and a fifth compensation for business-entity related information (e.g. an employment-related information, a management-related information, a marketing-related information, a sales-related information, a plan-related information, a profit-related information, a loss-related information, an asset-related information, a liability-related information, an inventory-related an employment-related activity, a management-related activity, a marketing-related activity, a sales-related activity, a plan-related activity, a profit-related activity, a loss-related activity, an asset-related activity, a liability-related activity, an inventory-related activity, and an overhead-related acti, and an overhead-related information, etc.).

As further shown in FIG. 12, in further implementations, facilitating an arrangement between a data provider and a data consumer regarding one or more data-provider-related search activities at 310 may include arranging for varying levels of compensation to be received from a data consumer in exchange for varying amounts of data gathering associated with the data provider at 1216 (e.g. arranging for $1 per unit of information provided; arranging for $1 per unit of information provided during a first week, and $0.5 per unit of information provided during a second week; arranging for 1000 yen per unit for the first million units, 1100 yen per unit for the second million units, 1200 per unit for the third million units, etc.).

Similarly, in other implementations, facilitating an arrangement between a data provider and a data consumer regarding one or more data-provider-related search activities at 310 may include arranging for different levels of compensation to be received from a data consumer in exchange for different fields of use associated with the data gathering at 1218 (e.g. arranging for compensation of $1 per unit of information for online advertising uses, $0.05 per unit for medical research uses, etc.; arranging for a 20% discount on the cost of goods or services for targeted marketing uses, and a 2% discount on the cost of goods or services for product development uses, etc.).

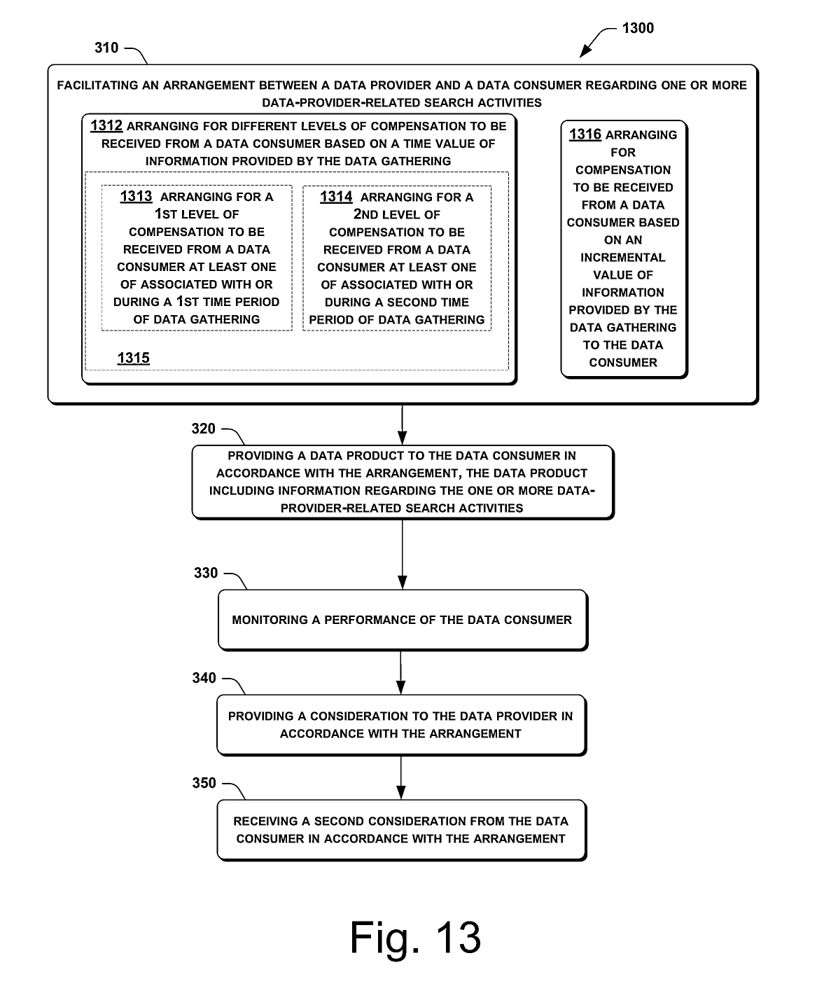

With reference to FIG. 13, in at least some implementations, facilitating an arrangement between a data provider and a data consumer regarding one or more data-provider-related search activities at 310 may include arranging for different levels of compensation to be received from a data consumer based on a time value of information provided by the data gathering at 1312 (e.g. arranging for a first compensation for information provided during an early time period, and a second compensation for information provided during a later time period). In some implementations, arranging for different levels of compensation to be received from a data consumer based on a time value of information provided by the data gathering at 1312 may include arranging for a first level of compensation to be received from a data consumer associated with a first time period of data gathering at 1313 (e.g. a higher compensation provided during an earlier time period), arranging for a second level of compensation to be received from the data consumer associated with a second time period of data gathering at 1314 (e.g. a lower compensation provided during a later time period), or both at 1315 (e.g. a lower compensation provided during an earlier time period and a higher compensation provided during a later time period).

As further shown in FIG. 13, in some implementations, facilitating an arrangement between a data provider and a data consumer regarding one or more data-provider-related search activities at 310 may include arranging for compensation to be received from a data consumer based on an incremental value of information provided by the data gathering to the data consumer at 1316. For example, the compensation to be received from a data consumer may be based on the data consumer's increase in revenue, sales volume, traffic, or other indicator of incremental value (actual or presumed).

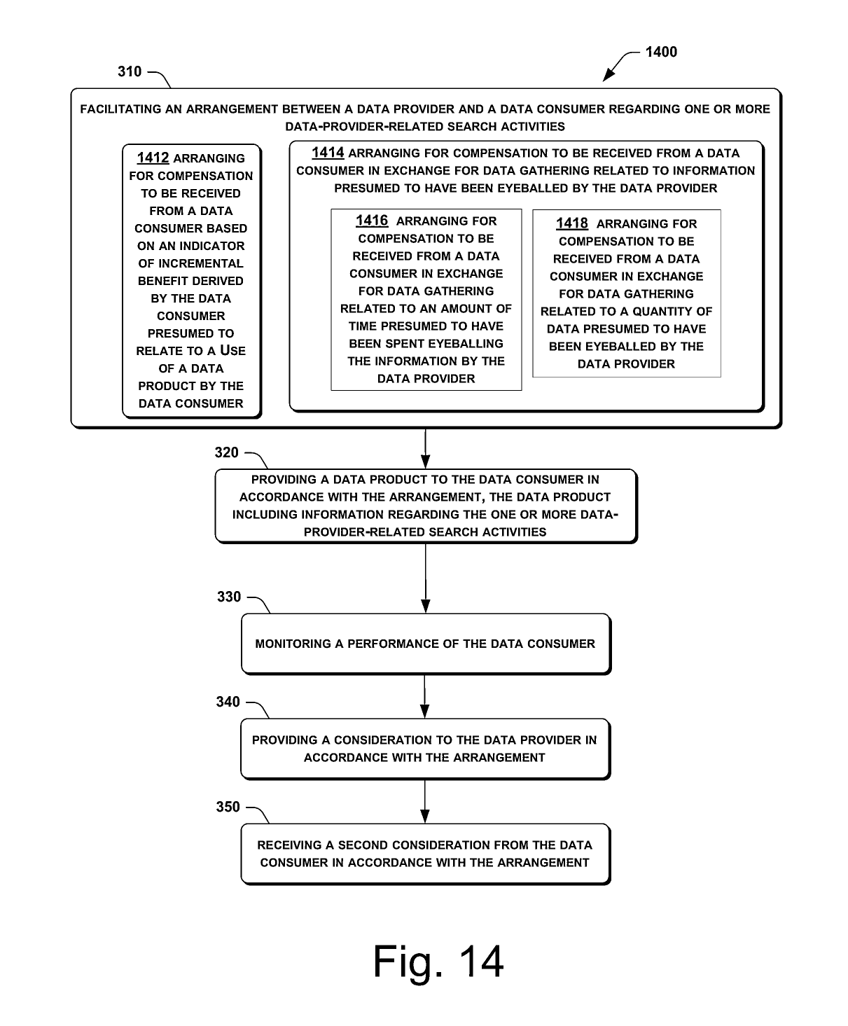

With reference to FIG. 14, in some implementations, facilitating an arrangement between a data provider and a data consumer regarding one or more data-provider-related search activities at 310 may include arranging for compensation to be received from a data consumer based on an indicator of incremental benefit derived by the data consumer presumed to relate to a use of a data product by the data consumer at 1412. Again, for example, the compensation to be received from a data consumer may be based on the data consumer's increase in revenue, sales volume, network traffic (e.g. website visits, hits, orders, etc.), or any other suitable indicator of incremental benefit derived by the data consumer presumed to relate to a use of a data product.

In further implementations, compensation to be received from a data consumer may be arranged based on information presumed to have been “eyeballed” (including information actually eyeballed) by the data provider. For example, as further shown in FIG. 14, in some implementations, facilitating an arrangement between a data provider and a data consumer regarding one or more data-provider-related search activities at 310 may include arranging for compensation to be received from a data consumer in exchange for data gathering related to information presumed to have been eyeballed by the data provider at 1414 (e.g. arranging for compensation from an online advertiser based on an actual time spent having a webpage opened by a browser; arranging for compensation from an online retailer based on cursor movement or non-movement during a time a webpage remains opened by a browser, etc.).

More specifically, in some implementations, arranging for compensation to be received from a data consumer in exchange for data gathering related to information presumed to have been eyeballed by the data provider at 1414 may include arranging for compensation to be received from a data consumer in exchange for data gathering related to an amount of time presumed to have been spent eyeballing the information by the data provider at 1416 (e.g. arranging for compensation from a marketing consultant based on a time period spent browsing various websites; arranging for compensation from an online search provider based on scrolling history during browsing activities, etc.). In further implementations, arranging for compensation to be received from a data consumer in exchange for data gathering related to information presumed to have been eyeballed by the data provider 1414 may include arranging for compensation to be received from a data consumer in exchange for data gathering related to a quantity of data presumed to have been eyeballed by the data provider at 1418 (e.g. arranging for compensation from a data consumer based on a number of sites visited by a data provider prior to making a purchase; arranging for compensation based on numbers of pages viewed by a data provider during browsing activities, etc.).

Generally, the activities associated with facilitating an arrangement between a data provider and a data consumer regarding one or more data-provider-related search activities at 310 may be accomplished in an automated or semi-automated manner, and may use the communications 120 between the data providers 110 and the data broker 130, or the communications 150 between the data broker 130 and the data consumer 170, or both. Additionally, such activities may be accomplished via one or more of telephony (e.g. using the public switched telephone system), the internet (e.g., Voice over Internet Protocol), cellular telephone systems, satellite communication systems, instant messaging, text messaging, electronic mail (“email”), facsimiles, written communications, or any other suitable communications systems, and may be accomplished using any suitably operable couplings between the data broker 130 and the one or more data providers 110 and data consumers 170, including physical connections (e.g. wires, cables, fiber-optic lines, etc.), or wireless connections (e.g. radio-frequency connections between cell phone and cell network towers, satellite towers, etc.) and/or some combination of physical connections and wireless connections, and may be accomplished using computing devices (e.g. computing device 200, servers, laptops, mainframes, personal data assistants, cell phones, etc.), or using one or more components of such devices (e.g. processors 202, special purpose circuitry 282, application programs 232, other program modules 234, program data 236, network interface 252, wireless interface 255, serial port interface 242, other interfaces 216, 222, 228, etc.), or any other suitable systems or methods.

It should be appreciated that the particular embodiments of processes described herein are merely possible implementations of the present disclosure, and that the present disclosure is not limited to the particular implementations described herein and shown in the accompanying figures. For example, in alternate implementations, certain acts need not be performed in the order described, and may be modified, and/or may be omitted entirely, depending on the circumstances. Moreover, in various implementations, the acts described may be implemented by a computer, controller, processor, programmable device, or any other suitable device, and may be based on instructions stored on one or more computer-readable media or otherwise stored or programmed into such devices. In the event that computer-readable media are used, the computer-readable media can be any available media that can be accessed by a device to implement the instructions stored thereon.

Various methods, systems, and techniques may be described and implemented in the general context of computer-executable instructions, such as program modules, executed by one or more processors or other devices. Generally, program modules include routines, programs, objects, components, data structures, etc. that perform particular tasks or implement particular abstract data types. Typically, the functionality of the program modules may be combined or distributed as desired in various alternate embodiments. In addition, embodiments of these methods, systems, and techniques may be stored on or transmitted across some form of computer readable media.

It may also be appreciated that there may be little distinction between hardware and software implementations of aspects of systems and methods disclosed herein. The use of hardware or software may generally be a design choice representing cost vs. efficiency tradeoffs, however, in certain contexts the choice between hardware and software can become significant. Those having skill in the art will appreciate that there are various vehicles by which processes, systems, and technologies described herein can be effected (e.g., hardware, software, firmware, or combinations thereof), and that a preferred vehicle may vary depending upon the context in which the processes, systems, and technologies are deployed. For example, if an implementer determines that speed and accuracy are paramount, the implementer may opt for a mainly hardware and/or firmware vehicle. Alternatively, if flexibility is paramount, the implementer may opt for a mainly software implementation. In still other implementations, the implementer may opt for some combination of hardware, software, and/or firmware. Hence, there are several possible vehicles by which the processes and/or devices and/or other technologies described herein may be effected, and which may be desired over another may be a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Those skilled in the art will recognize that it is common within the art to describe devices and/or processes in the fashion set forth herein, and thereafter use standard engineering practices to integrate such described devices and/or processes into workable systems having the described functionality. That is, at least a portion of the devices and/or processes described herein can be developed into a workable system via a reasonable amount of experimentation.

The herein described aspects and drawings illustrate different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” (or “operatively connected,” or “operatively coupled”) to each other to achieve the desired functionality, and any two components capable of being so associated can also be viewed as being “operably couplable” (or “operatively couplable”) to each other to achieve the desired functionality. Specific examples of operably couplable include but are not limited to physically mateable and/or physically interacting components and/or wirelessly interactable and/or wirelessly interacting components and/or logically interacting and/or logically interactable components.

Those skilled in the art will recognize that some aspects of the embodiments disclosed herein can be implemented in standard integrated circuits, and also as one or more computer programs running on one or more computers, and also as one or more software programs running on one or more processors, and also as firmware, as well as virtually any combination thereof. It will be further understood that designing the circuitry and/or writing the code for the software and/or firmware could be accomplished by a person skilled in the art in light of the teachings and explanations of this disclosure.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. For example, in some embodiments, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in standard integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein are capable of being distributed as a program product in a variety of forms, and that an illustrative embodiment of the subject matter described herein applies equally regardless of the particular type of signal bearing media used to actually carry out the distribution. Examples of a signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of this subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.).

As a further example of “open” terms in the present specification and claims, it will be understood that usage of a language construction “A or B” is generally interpreted as a non-exclusive “open term” meaning. A alone, B alone, and/or A and B together.

Although various features have been described in considerable detail with reference to certain preferred embodiments, other embodiments are possible. Therefore, the spirit or scope of the appended claims should not be limited to the description of the embodiments contained herein.

1. A computer-implemented method, comprising:
facilitating an arrangement between a data provider and a data consumer regarding one or more data-provider-related search activities;
providing a data product to the data consumer in accordance with the arrangement, the data product including information regarding the one or more data-provider-related search activities;
providing a consideration to the data provider in accordance with the arrangement; and
receiving a second consideration from the data consumer in accordance with the arrangement.

2. The computer-implemented method of claim 1, wherein providing a consideration to the data provider in accordance with the arrangement comprises:
providing a consideration to the data provider in exchange for at least one of installation of or access to a data tracking component related to at least one user interface associated with the data provider.

3. The computer-implemented method of claim 1, wherein providing a consideration to the data provider in accordance with the arrangement comprises:
providing a consideration to the data provider in exchange for at least one of installation of or access to a data tracking component related to at least one networking device associated with the data provider.

4. The computer-implemented method of claim 1, wherein providing a consideration to the data provider in accordance with the arrangement comprises:
providing a consideration to the data provider in exchange for at least one of installation of or access to a data tracking component related to at least one computing device associated with the data provider.

5. The computer-implemented method of claim 1, wherein providing a consideration to the data provider in accordance with the arrangement comprises:
providing a consideration to the data provider in exchange for at least one of installation of or access to a data tracking component related to at least one communication device associated with the data provider.

6. The computer-implemented method of claim 1, wherein providing a consideration to the data provider in accordance with the arrangement comprises:
providing a consideration to the data provider in exchange for at least one of installation of or access to a data tracking component related to at least one navigational device associated with the data provider.

7. The computer-implemented method of claim 1, wherein providing a consideration to the data provider in accordance with the arrangement comprises:
providing a consideration to the data provider in exchange for data gathering activities related to at least one user interface associated with the data provider.

8. The computer-implemented method of claim 1, wherein providing a consideration to the data provider in accordance with the arrangement comprises:
providing a consideration to the data provider in exchange for data gathering activities related to at least one networking device associated with the data provider.

9. The computer-implemented method of claim 1, wherein providing a consideration to the data provider in accordance with the arrangement comprises:
providing a consideration to the data provider in exchange for data gathering activities related to at least one computing device associated with the data provider.

10. The computer-implemented method of claim 1, wherein providing a consideration to the data provider in accordance with the arrangement comprises:
providing a consideration to the data provider in exchange for data gathering activities related to at least one communication device associated with the data provider.

11. The computer-implemented method of claim 1, wherein providing a consideration to the data provider in accordance with the arrangement comprises:
providing a consideration to the data provider in exchange for data gathering activities related to at least one navigational device associated with the data provider.

12-14. (canceled)

15. The computer-implemented method of claim 1, wherein providing a consideration to the data provider in accordance with the arrangement comprises:
providing a consideration at least partially based on an indicator of incremental benefit derived by the data consumer presumed to relate to a use of the data product by the data consumer.

16. The computer-implemented method of claim 1, wherein providing a consideration to the data provider in accordance with the arrangement comprises:
providing a consideration at least partially based on an indicator of networking traffic presumed to relate to a use of the data product by the data consumer.

17. The computer-implemented method of claim 1, wherein providing a consideration to the data provider in accordance with the arrangement comprises:
providing a consideration at least partially based on an indicator of advertising effectiveness presumed to relate to a use of the data product by the data consumer.

18. The computer-implemented method of claim 1, wherein providing a consideration to the data provider in accordance with the arrangement comprises:
providing a consideration at least partially based on an indicator of improved market share presumed to relate to a use of the data product by the data consumer.

19. The computer-implemented method of claim 1, wherein facilitating an arrangement between a data provider and a data consumer regarding one or more data-provider-related search activities comprises:
negotiating the arrangement between the data provider and the data consumer for access to information regarding the one or more data-provider-related search activities.

20-23. (canceled)

24. The computer-implemented method of claim 1, wherein facilitating an arrangement between a data provider and a data consumer regarding one or more data-provider-related search activities comprises:
arranging for consideration to be received from a data consumer in exchange for data gathering related to at least one networking device associated with the data provider.

25. The computer-implemented method of claim 1, wherein facilitating an arrangement between a data provider and a data consumer regarding one or more data-provider-related search activities comprises:
arranging for compensation to be received from a data consumer in exchange for data gathering related to at least one computing device associated with the data provider.

26. The computer-implemented method of claim 1, wherein facilitating an arrangement between a data provider and a data consumer regarding one or more data-provider-related search activities comprises:
arranging for compensation to be received from a data consumer in exchange for data gathering related to at least one personal communications device associated with the data provider.

27. The computer-implemented method of claim 1, wherein facilitating an arrangement between a data provider and a data consumer regarding one or more data-provider-related search activities comprises:
arranging for a first level of compensation to be received from a data consumer in exchange for data gathering related to a first type of information associated with the data provider; and
arranging for a second level of compensation to be received from the data consumer in exchange for data gathering related to a second type of information associated with the data provider, the second level of compensation being different than the first level of compensation.

28. The computer-implemented method of claim 1, wherein facilitating an arrangement between a data provider and a data consumer regarding one or more data-provider-related search activities comprises:
arranging for a plurality of compensation levels to be received from a data consumer in exchange for data gathering related to different types of information associated with the data provider.

29-30. (canceled)

31. The computer-implemented method of claim 1, wherein facilitating an arrangement between a data provider and a data consumer regarding one or more data-provider-related search activities comprises:
arranging for different levels of compensation to be received from a data consumer in exchange for different fields of use associated with the data gathering.

32. The computer-implemented method of claim 1, wherein facilitating an arrangement between a data provider and a data consumer regarding one or more data-provider-related search activities comprises:
arranging for different levels of compensation to be received from a data consumer based on a time value of information provided by the data gathering.

33. The computer-implemented method of claim 32, wherein arranging for different levels of compensation to be received from a data consumer based on a time value of information provided by the data gathering comprises:
arranging for a first level of compensation to be received from a data consumer associated with a first time period of data gathering; and
arranging for a second level of compensation to be received from the data consumer associated with a second time period of data gathering.

34. The computer-implemented method of claim 1, wherein facilitating an arrangement between a data provider and a data consumer regarding one or more data-provider-related search activities comprises:
arranging for compensation to be received from a data consumer based on an incremental value of information provided by the data gathering to the data consumer.

35. The computer-implemented method of claim 1, wherein facilitating an arrangement between a data provider and a data consumer regarding one or more data-provider-related search activities comprises:
arranging for compensation to be received from a data consumer based on an indicator of incremental benefit derived by the data consumer presumed to relate to a use of a data product by the data consumer.

36-38. (canceled)

39. The computer-implemented method of claim 1, further comprising:
monitoring a performance of the data consumer.

40. The computer-implemented method of claim 1, wherein monitoring a performance of the data consumer comprises:
monitoring an indicator of incremental benefit derived by the data consumer presumed to relate to a use of the data product by the data consumer.

41. The computer-implemented method of claim 1, wherein monitoring a performance of the data consumer comprises:
monitoring an indicator of networking traffic presumed to relate to a use of the data product by the data consumer.

42. The computer-implemented method of claim 1, wherein monitoring a performance of the data consumer comprises:
monitoring an indicator of advertising effectiveness presumed to relate to a use of the data product by the data consumer.

43. The computer-implemented method of claim 1, wherein monitoring a performance of the data consumer comprises:
monitoring an indicator of increased market share presumed to relate to a use of the data product by the data consumer.

44. An apparatus, comprising:
means for facilitating an arrangement between a data provider and a data consumer regarding one or more data-provider-related search activities;
means for providing a data product to the data consumer in accordance with the arrangement, the data product including information regarding the one or more data-provider-related search activities;
means for providing a consideration to the data provider in accordance with the arrangement; and
means for receiving a second consideration from the data consumer in accordance with the arrangement.

45-86. (canceled)

87. A system, comprising:
circuitry for facilitating an arrangement between a data provider and a data consumer regarding one or more data-provider-related search activities;
circuitry for providing a data product to the data consumer in accordance with the arrangement, the data product including information regarding the one or more data-provider-related search activities;
circuitry for providing a consideration to the data provider in accordance with the arrangement; and
circuitry for receiving a second consideration from the data consumer in accordance with the arrangement.
